(19) United States
(12) Patent Application Publication
(10) Pub. No.: US 2025/0193747 A1
(43) Pub. Date: Jun. 12, 2025

(54) METHOD AND APPARATUS FOR CONFIGURATION AND EXECUTION OF MEASUREMENT IN CELL SWITCH PROCEDURE CONSIDERING DUAL CONNECTIVITY

(71) Applicant: ELECTRONICS AND TELECOMMUNICATIONS RESEARCH INSTITUTE, Daejeon (KR)

(72) Inventors: Soongi PARK, Daejeon (KR); Jun Sik KIM, Daejeon (KR); Young-Jo KO, Daejeon (KR); Kwang Seon KIM, Daejeon (KR)

(73) Assignee: ELECTRONICS AND TELECOMMUNICATIONS RESEARCH INSTITUTE, Daejeon (KR)

(21) Appl. No.: 18/972,000

(22) Filed: Dec. 6, 2024

(30) Foreign Application Priority Data
Dec. 7, 2023 (KR) 10-2023-0177128
Dec. 5, 2024 (KR) 10-2024-0179901

(51) Int. Cl. H04W 36/00; H04W 56/00; H04W 76/20

(52) U.S. Cl. CPC H04W 36/0016; H04W 36/0058; H04W 56/0015; H04W 76/20

(57) ABSTRACT

A method of a user equipment (UE) may comprise: performing a lower-layer triggered mobility (LTM) preparation phase for LTM candidate configuration; executing an LTM procedure based on a layer-1 (L1) measurement result for one or more candidate cells indicated by the LTM candidate configuration; and completing the LTM procedure when a cell switch procedure according to the LTM procedure is completed.

### CROSS-REFERENCE TO RELATED APPLICATIONS

This application claims priority to Korean Patent Applications No. 10-2023-0177128, filed on Dec. 7, 2023, and No. 10-2024-0179901, filed on Dec. 5, 2024, with the Korean Intellectual Property Office (KIPO), the entire contents of which are hereby incorporated by reference.

### BACKGROUND

### 1. Technical Field

The present disclosure relates to a cell switch technique, and more particularly, to a technique for configuring and executing measurement in a cell switch procedure considering dual connectivity.

### 2. Related Art

With the advancement of information and communication technology, various wireless communication technologies are being developed. The representative wireless communication technologies may be long term evolution (LTE), LTE-advanced (LTE-A), new radio (NR), and the like specified as the 3^{rd} generation partnership project (3GPP) standards. The LTE and/or LTE-A may be 4^{th} generation (4G) communication technology. The NR may be a 5^{th} generation (5G) communication technology.

The 5G communication system (e.g. communication system supporting the NR) using a higher frequency band (e.g. a frequency band of 6 GHz or above) than a frequency band (e.g. a frequency band of 6 GHz or below) of the 4G communication system is being considered for processing of soaring wireless data after commercialization of the 4G communication system (e.g. communication system supporting the LTE and/or LTE-A). The 5G communication system may support enhanced Mobile BroadBand (eMBB), Ultra Reliable Low Latency Communication (URLLC), and/or Massive Machine Type Communication (mMTC).

Standardization of a lower-layer triggered mobility (LTM) procedure is underway in the 3GPP standardization meetings. The LTM procedure can support faster signaling compared to the conventional handover procedure. Through the LTM procedure, reliability of a control plane (CP) and/or performance of a user plane (UP) can be improved. It is necessary to define specific methods for measurement configuration and/or measurement execution for the LTM procedure.

### SUMMARY

The present disclosure for resolving the above-described problems is directed to providing a method and apparatus for configuring and executing measurement in a cell switch procedure considering dual connectivity.

A method of a user equipment (UE), according to exemplary embodiments of the present disclosure, may comprise: performing a lower-layer triggered mobility (LTM) preparation phase for LTM candidate configuration; executing an LTM procedure based on a layer-1 (L1) measurement result for one or more candidate cells indicated by the LTM candidate configuration; and completing the LTM procedure when a cell switch procedure according to the LTM procedure is completed.

The performing of the LTM preparation phase may comprise: transmitting a measurement report to a base station; receiving, from the base station, a radio resource control (RRC) reconfiguration message including the LTM candidate configuration generated based on the measurement report; and transmitting an RRC reconfiguration complete message to the base station in response to the RRC reconfiguration message.

The LTM candidate configuration may include at least one of a master cell group (MCG) list or a secondary cell group (SCG) list, the MCG list may include information on one or more candidate MCGs which the UE is able to access, and the SCG list may include information on one or more candidate SCGs which the UE is able to access.

The RRC reconfiguration message may further include L1 measurement configuration, wherein the L1 measurement configuration may include information on one or more beam measurement instances that are to be measured.

The one or more beam measurement instances indicated by the L1 measurement configuration may be one or more beam measurement instances having a high priority among all beam measurement instances for all candidate beams.

The one or more beam measurement instances having the high priority may include at least one of a beam measurement instance for an MCG primary cell (PCell), a beam measurement instance for an SCG primary secondary cell (PSCell), or a beam measurement instance for a beam affecting at a cell boundary.

The executing of the LTM procedure may comprise: transmitting an L1 measurement report to a base station; in response to execution of the LTM procedure being determined based on the L1 measurement report, receiving a cell switch command from the base station; and performing a detach procedure for a source cell and a procedure of applying configuration for a target cell, wherein the L1 measurement report may include a measurement result for the one or more candidate cells indicated by the LTM candidate configuration.

The L1 measurement report may include at least one of a cell identifier (ID), beam information of a cell corresponding to the cell ID, or a triggering condition of the L1 measurement report.

The cell switch command may include at least one of information indicating a type of a cell group (CG) which the UE is to access or an index for the CG which the UE is to access, and the type of the CG indicates MCG or SCG.

The method may further comprise: before executing the LTM procedure, performing an early synchronization procedure for the one or more candidate cells indicated by the LTM candidate configuration, wherein the early synchronization procedure may include at least one of a downlink (DL) synchronization procedure or an uplink (UL) synchronization procedure.

A method of a base station, according to exemplary embodiments of the present disclosure, may comprise: performing, with a user equipment (UE), a lower-layer triggered mobility (LTM) preparation phase for LTM candidate configuration; executing an LTM procedure for the UE based on a layer-1 (L1) measurement result for one or more candidate cells indicated by the LTM candidate configuration; and completing the LTM procedure when a cell switch procedure according to the LTM procedure is completed.

The performing of the LTM preparation phase with the UE may comprise: receiving a measurement report from the UE; generating the LTM candidate configuration based on the measurement report; transmitting, to the UE, a radio resource control (RRC) reconfiguration message including the LTM candidate configuration; and receiving an RRC reconfiguration complete message from the UE in response to the RRC reconfiguration message.

The LTM candidate configuration may include at least one of a master cell group (MCG) list or a secondary cell group (SCG) list, the MCG list may include information on one or more candidate MCGs which the UE is able to access, and the SCG list may include information on one or more candidate SCGs which the UE is able to access.

The RRC reconfiguration message may further include L1 measurement configuration, wherein the L1 measurement configuration may include information on one or more beam measurement instances that are to be measured.

The one or more beam measurement instances indicated by the L1 measurement configuration may be one or more beam measurement instances having a high priority among all beam measurement instances for all candidate beams.

The executing of the LTM procedure may comprise: receiving an L1 measurement report from the UE; determining whether to execute the LTM procedure based on the L1 measurement report; and in response to determining to execute the LTM procedure, transmitting a cell switch command to the UE, wherein the L1 measurement report may include a measurement result for the one or more candidate cells indicated by the LTM candidate configuration.

The L1 measurement report may include at least one of a cell identifier (ID), beam information of a cell corresponding to the cell ID, or a triggering condition of the L1 measurement report.

The cell switch command may include at least one of information indicating a type of a cell group (CG) which the UE is access or an index for the CG which the UE is to access, and the type of the CG indicates MCG or SCG.

A user equipment (UE), according to exemplary embodiments of the present disclosure, may comprise at least one processor, and the at least one processor may cause the UE to perform: performing a lower-layer triggered mobility (LTM) preparation phase for LTM candidate configuration; executing an LTM procedure based on a layer-1 (L1) measurement result for one or more candidate cells indicated by the LTM candidate configuration; and completing the LTM procedure when a cell switch procedure according to the LTM procedure is completed.

In the performing of the LTM preparation phase, the at least one processor may cause the UE to perform: transmitting a measurement report to a base station; receiving, from the base station, a radio resource control (RRC) reconfiguration message including the LTM candidate configuration generated based on the measurement report; and transmitting an RRC reconfiguration complete message to the base station in response to the RRC reconfiguration message.

According to the present disclosure, an LTM preparation phase, LTM execution phase, and LTM completion phase can be performed between a user equipment (UE) and a base station. Through the above-described phases, the LTM procedure can be executed efficiently. The UE can perform measurements on candidate beam(s) indicated by the base station, instead of measuring all candidate beams of all candidate cells. Accordingly, the measurement burden for candidate beam(s) can be reduced. In the LTM execution phase, an L1 measurement report and a cell switch command can be simplified, thereby reducing signaling overhead.

### BRIEF DESCRIPTION OF DRAWINGS

FIG. 1 is a conceptual diagram illustrating exemplary embodiments of a communication system.

FIG. 2 is a block diagram illustrating exemplary embodiments of an apparatus.

FIG. 3 is a conceptual diagram illustrating a mobility management method according to an operational state of a user equipment (UE).

FIGS. 4A and 4B are conceptual diagrams illustrating DC environments.

FIG. 5 is a conceptual diagram illustrating an inter-cell mobility procedure.

FIG. 6 is a sequence chart illustrating basic steps of an inter-cell mobility LTM procedure.

FIG. 7 is a conceptual diagram illustrating inter-cell mobility in various cases.

FIGS. 8A and 8B are sequence charts illustrating signaling procedures between communication nodes.

FIG. 9 is a conceptual diagram illustrating protocol stacks in the CP and UP.

FIGS. 10A and 10B are conceptual diagrams illustrating bearer configurations in the UP.

FIG. 11A is a conceptual diagram illustrating an LTM MCG list, and FIG. 11B is a conceptual diagram illustrating an SCG list.

FIG. 12 is a conceptual diagram illustrating an L1 measurement configuration scheme.

FIGS. 13A and 13B are conceptual diagrams illustrating beam indexes.

FIG. 14A is a block diagram illustrating a MAC CE for L1 measurement reporting in PH2 of FIG. 6.

FIG. 14B is a block diagram illustrating a MAC CE for a cell switch command in PH2 of FIG. 6.

FIGS. 15A, 15B, and 15C are conceptual diagrams illustrating a communication system that includes two cells.

FIG. 16 is a conceptual diagram illustrating processes for (b)3 and (b)4 of the CD type 2 in Table 8.

FIG. 17 is a conceptual diagram illustrating processes for (c)3 and (c)4 of the CD type 3 in Table 9.

### DETAILED DESCRIPTION OF THE EMBODIMENTS

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

Hereinafter, forms of the present disclosure will be described in detail with reference to the accompanying drawings. In describing the disclosure, to facilitate the entire understanding of the disclosure, like numbers refer to like elements throughout the description of the figures and the repetitive description thereof will be omitted.

A communication system to which exemplary embodiments according to the present disclosure are applied will be described. The communication system may be the 4G communication system (e.g. Long-Term Evolution (LTE) communication system or LTE-A communication system), the 5G communication system (e.g. New Radio (NR) communication system), the sixth generation (6G) communication system, or the like. The 4G communication system may support communications in a frequency band of 6 GHz or below, and the 5G communication system may support communications in a frequency band of 6 GHz or above as well as the frequency band of 6 GHz or below. The communication system to which the exemplary embodiments according to the present disclosure are applied is not limited to the contents described below, and the exemplary embodiments according to the present disclosure may be applied to various communication systems. Here, the communication system may be used in the same sense as a communication network, ‘LTE’ may refer to ‘4G communication system’, ‘LTE communication system’, or ‘LTE-A communication system’, and ‘NR’ may refer to ‘5G communication system’ or ‘NR communication system’.

In exemplary embodiments, “an operation (e.g. transmission operation) is configured to a communication node” may mean that “configuration information (e.g. information element(s) or parameter(s)) for the operation” and/or “information instructing to perform the operation” is signaled to the communication node. In other words, “an operation (e.g. transmission operation) is configured to a communication node” may mean that the communication node receives “configuration information (e.g. information element(s) or parameter(s)) for the operation” and/or “information instructing to perform the operation”. “Information element(s) (e.g. parameter(s)) are configured to a communication node” may refer to “the information element(s) are signaled to the communication node (e.g. the communication node receives the information element(s))”. The signaling may be at least one of system information (SI) signaling (e.g. transmission of system information block (SIB) and/or master information block (MIB)), RRC signaling (e.g. transmission of RRC parameters and/or higher layer parameters), MAC control element (CE) signaling, or PHY signaling (e.g. transmission of downlink control information (DCI), uplink control information (UCI), and/or sidelink control information (SCI)).

In the present disclosure, “time” may refer to a “time point,” and a “time point” may refer to “time.” “Time” and “time point” may be used interchangeably. A reception time of a signal or channel may refer to a reception start time or reception end time. A transmission time of a signal or channel may refer to a transmission start time or transmission end time.

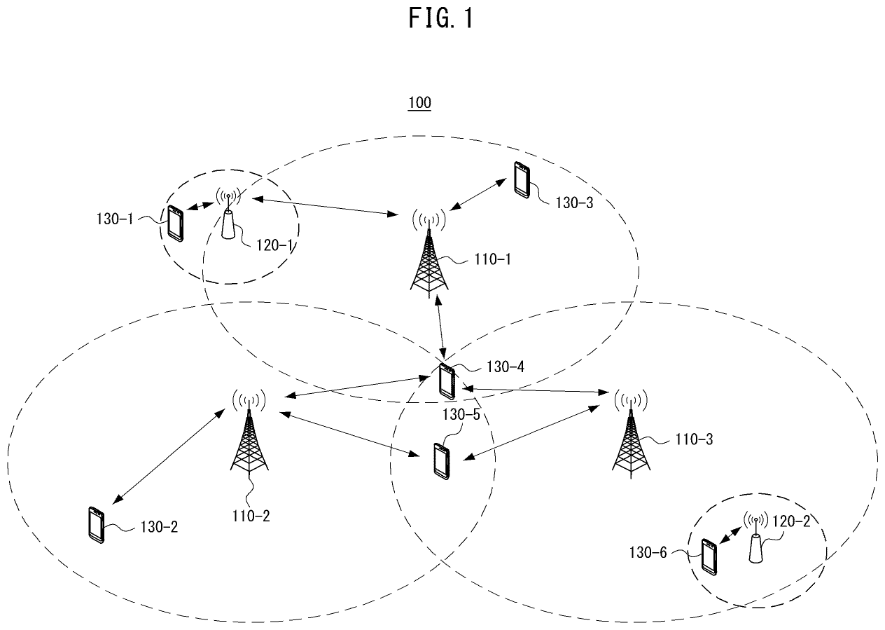

FIG. 1 is a conceptual diagram illustrating exemplary embodiments of a communication system.

Referring to FIG. 1, a communication system 100 may include a plurality of communication nodes 110-1, 110-2, 110-3, 120-1, 120-2, 130-1, 130-2, 130-3, 130-4, 130-5, and 130-6. In addition, the communication system 100 may further include a core network (e.g. serving-gateway (S-GW), packet data network (PDN)-gateway (P-GW), and mobility management entity (MME)). When the communication system 100 is the 5G communication system (e.g. NR system), the core network may include an access and mobility management function (AMF), a user plane function (UPF), a session management function (SMF), and the like.

The plurality of communication nodes 110 to 130 may support the communication protocols (e.g. LTE communication protocol, LTE-A communication protocol, NR communication protocol, etc.) defined by technical specifications of 3rd generation partnership project (3GPP). The plurality of communication nodes 110 to 130 may support a code division multiple access (CDMA) based communication protocol, a wideband CDMA (WCDMA) based communication protocol, a time division multiple access (TDMA) based communication protocol, a frequency division multiple access (FDMA) based communication protocol, an orthogonal frequency division multiplexing (OFDM) based communication protocol, a filtered OFDM based communication protocol, a cyclic prefix OFDM (CP-OFDM) based communication protocol, a discrete Fourier transform spread OFDM (DFT-s-OFDM) based communication protocol, an orthogonal frequency division multiple access (OFDMA) based communication protocol, a single carrier FDMA (SC-FDMA) based communication protocol, a non-orthogonal multiple access (NOMA) based communication protocol, a generalized frequency division multiplexing (GFDM) based communication protocol, a filter bank multi-carrier (FBMC) based communication protocol, a universal filtered multi-carrier (UFMC) based communication protocol, a space division multiple access (SDMA) based communication protocol, or the like. Each of the plurality of communication nodes may refer to an apparatus or a device. The exemplary embodiments may be performed by the apparatus or device. A structure of the apparatus (e.g. device) may be as follows.

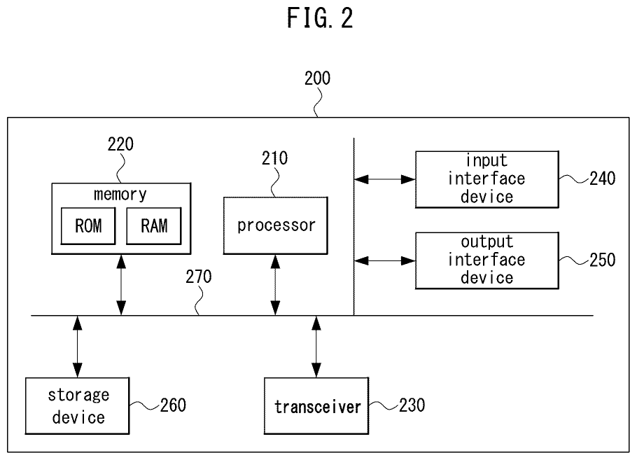

FIG. 2 is a block diagram illustrating exemplary embodiments of an apparatus.

Referring to FIG. 2, an apparatus 200 may comprise at least one processor 210, a memory 220, and a transceiver 230 connected to the network for performing communications. Also, the apparatus 200 may further comprise an input interface device 240, an output interface device 250, a storage device 260, and the like. The respective components included in the apparatus 200 may communicate with each other as connected through a bus 270.

The processor 210 may execute a program stored in at least one of the memory 220 and the storage device 260. The processor 210 may refer to a central processing unit (CPU), a graphics processing unit (GPU), or a dedicated processor on which methods in accordance with exemplary embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to cell coverage of the first base station 110-1. Also, the second terminal 130-2, the fourth terminal 130-4, and the fifth terminal 130-5 may belong to cell coverage of the second base station 110-2. Also, the fifth base station 120-2, the fourth terminal 130-4, the fifth terminal 130-5, and the sixth terminal 130-6 may belong to cell coverage of the third base station 110-3. Also, the first terminal 130-1 may belong to cell coverage of the fourth base station 120-1, and the sixth terminal 130-6 may belong to cell coverage of the fifth base station 120-2.

Here, each of the plurality of base stations 110-1, 110-2, 110-3, 120-1, and 120-2 may refer to a Node-B, an evolved Node-B (eNB), a gNB, an advanced base station (ABS), a high reliability-base station (HR-BS), a base transceiver station (BTS), a radio base station, a radio transceiver, an access point, an access node, a radio access station (RAS), a mobile multi-hop relay base station (MMR-BS), a relay station (RS), an advanced relay station (ARS), a high reliability-relay station (HR-RS), a home NodeB (HNB), a home eNodeB (HeNB), a roadside unit (RSU), a radio remote head (RRH), a transmission point (TP), a transmission and reception point (TRP), or the like.

Each of the plurality of terminals 130-1, 130-2, 130-3, 130-4, 130-5, and 130-6 may refer to a user equipment (UE), a terminal equipment (TE), an advanced mobile station (AMS), a high reliability-mobile station (HR-MS), a terminal, an access terminal, a mobile terminal, a station, a subscriber station, a mobile station, a portable subscriber station, a node, a device, an on board unit (OBU), or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul or a non-ideal backhaul, and exchange information with each other via the ideal or non-ideal backhaul. Also, each of the plurality of base stations 110-1, 110-2, 110-3, 120-1, and 120-2 may be connected to the core network through the ideal or non-ideal backhaul. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

In addition, each of the plurality of base stations 110-1, 110-2, 110-3, 120-1, and 120-2 may support a multi-input multi-output (MIMO) transmission (e.g. a single-user MIMO (SU-MIMO), a multi-user MIMO (MU-MIMO), a massive MIMO, or the like), a coordinated multipoint (CoMP) transmission, a carrier aggregation (CA) transmission, a transmission in unlicensed band, device-to-device (D2D) communication (or, proximity services (ProSe)), Internet of Things (IoT) communications, dual connectivity (DC), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2 (i.e. the operations supported by the plurality of base stations 110-1, 110-2, 110-3, 120-1, and 120-2). For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

The first base station 110-1, the second base station 110-2, and the third base station 110-3 may transmit a signal to the fourth terminal 130-4 in the CoMP transmission manner, and the fourth terminal 130-4 may receive the signal from the first base station 110-1, the second base station 110-2, and the third base station 110-3 in the CoMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

Exemplary embodiments of the present disclosure may be applied to NR communication systems and may also be applied to other communication systems (e.g. LTE communication systems, fifth generation (5G) communication systems, sixth generation (6G) communication systems, etc.).

In the present disclosure, method(s) for lower-layer triggered mobility (LTM) candidate configuration (e.g. layer 1 (L1) measurement configuration) during an LTM preparation phase of a new inter-cell mobility LTM procedure and/or method(s) for L1 measurement reporting and a cell switch command during an LTM execution phase of the new inter-cell mobility LTM procedure will be described. A cell switch procedure may refer to a beam switch procedure. In other words, the cell switch procedure may be applied to the beam switch procedure. If each cell uses a single beam, the cell switch procedure and the beam switch procedure may refer to the same procedure.

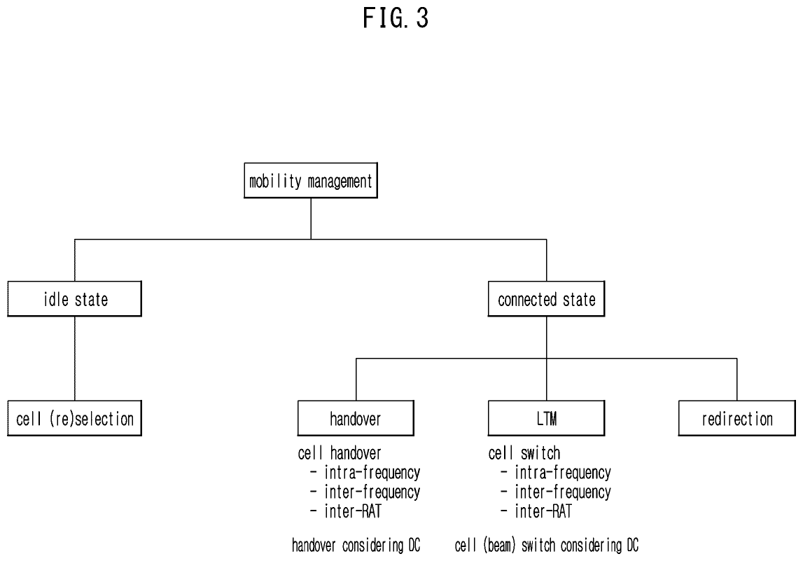

FIG. 3 is a conceptual diagram illustrating a mobility management method according to an operational state of a user equipment (UE).

Referring to FIG. 3, a mobility management method may be defined based on an operational state of a UE (e.g. idle state or connected state). The idle state of the UE (e.g. RRC idle state) may refer to an operational state of the UE existing in an environment without a dedicated radio connection. In other words, the idle state of the UE may indicate a state in which the UE is not connected to a base station. Mobility for the UE in the idle state may be managed through cell selection and/or cell reselection procedures. The mobility management method for the UE in the connected state (e.g. RRC connected state) may include a handover procedure (e.g. handover procedure for inter-cell mobility), LTM procedure, and/or redirection procedure.

To ensure signal reliability and/or maintain user plane (UP) performance by rapidly adapting to abrupt changes in a wireless channel condition in a high-frequency or ultra-high-frequency environment (e.g. environment using beams or beam sweeping), the LTM procedure may be introduced. The handover procedure may refer to a cell mobility procedure. The handover procedure may include a hard handover procedure, conditional handover procedure, random access channel (RACH)-less handover procedure, dual active protocol stack (DAPS) procedure, and the like.

In the present disclosure, methods for L1 measurement configuration, methods for L1 measurement reporting using a MAC control element (CE), and/or methods for LTM execution in the LTM procedure will be described. Additionally, considerations for an LTM procedure in a dual connectivity (DC) environment will be discussed.

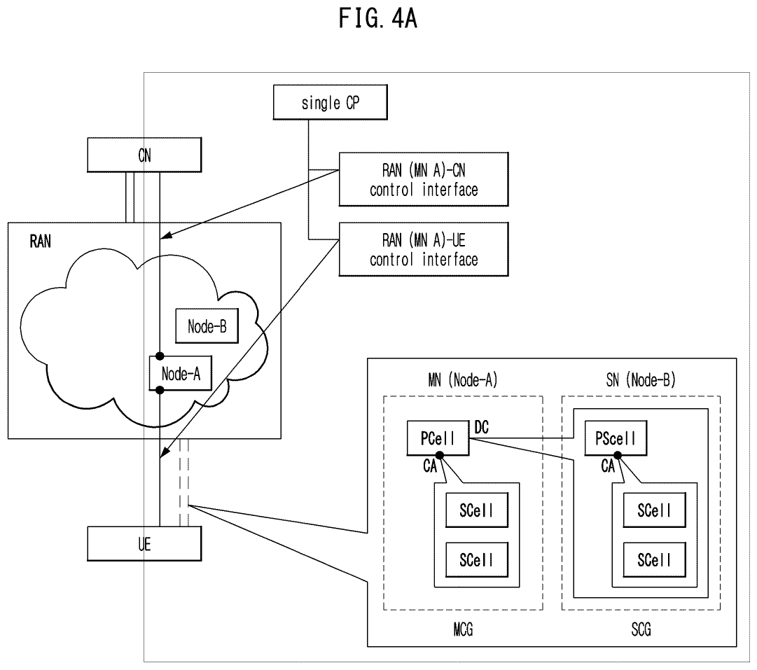

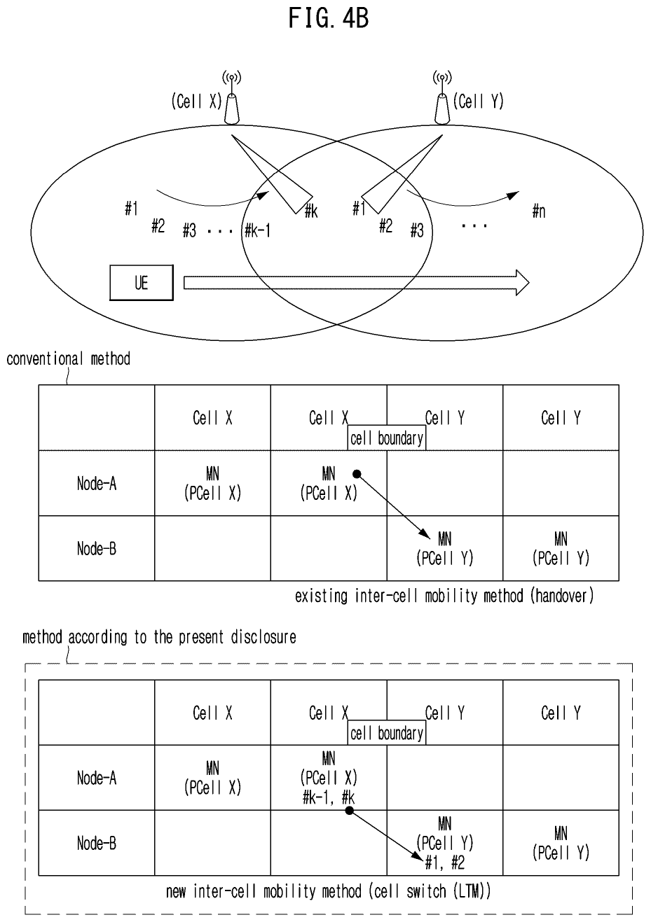

FIGS. 4A and 4B are conceptual diagrams illustrating DC environments.

Referring to FIGS. 4A and 4B, the present disclosure may be applied to DC environments illustrated in FIGS. 4A and 4B. In the exemplary embodiment shown in FIG. 4A, a UE may operate in the connected state. In a connection UE-radio access network (RAN)-core network (CN), a UE and an RAN may be connected through a dedicated wireless channel, and the RAN and a CN may be connected though a dedicated wired line. Node-A may serve as a master node (MN). Node-B may serve as a secondary node (SN). A single control plane (CP) may be connected through a dedicated wireless channel and a dedicated wired line in the connection UE-RAN (Node-A)-CN. Specifically, the dedicated wireless channel between the UE and the RAN may configured as an RAN (MN)-UE (wireless) control interface. The dedicated wired line between the RAN and the CN may be configured as an RAN (MN)-CN (wired) control interface.

From the MN perspective, a primary cell (PCell) may correspond to a core anchor cell for UE mobility management. The mobility management may be performed based on a quality of the PCell. MN secondary cells (i.e. SCells) which are associated with the PCell of the MN may exist. User data may be transmitted and received wirelessly through the MN PCell (e.g. the PCell of the MN) and MN SCells (e.g. the SCells of the MN) associated with the MN PCell based on CA. Control signals (e.g. RRC messages, MN RRC messages) may be transmitted through the PCell. The SN may be associated with the MN PCell through dual connectivity (DC). User data may be transmitted and received wirelessly through the SN. In other words, user data may be transmitted and received between the UE and the SN.

A wireless quality of a primary secondary cell (PSCell) of the SN (i.e. SN PSCell) may serve as a criterion for adding or releasing the SN. Based on CA, SN SCell(s) associated with the SN PSCell may exist. User data may be transmitted and received wirelessly through the SN PSCell and the SN SCell(s) (i.e. SCell(s) of the SN) associated with the SN PSCell based on CA. Control signals (e.g. RRC messages or SN RRC messages) may be transmitted through the PSCell. The SN RRC messages may be transmitted through network interfaces between the MN and the SN (e.g. next generation application protocol (NGAP) or next generation (NG)-control (C) interfaces), and may also be transmitted through a wireless interface between the MN and the UE via an MN RRC (i.e. RRC layer of the MN).

A group of the MN PCell and MN SCells used by the UE in the MN may be defined as a master cell group (MCG). Similarly, a group of the SN PSCell and SN SCells used by the UE in the SN may be defined as a secondary cell group (SCG). A wireless quality of the MN PCell may serve as an important criterion for mobility management, while a wireless quality of the SN PSCell may serve as a criterion for adding or releasing the SN with respect to the MN. From a wireless perspective, the MN PCell and SN PSCell may perform the same and/or similar function(s). Therefore, each of the PCell and PSCell may be collectively defined as a special cell (SpCell).

In the existing mobility management methods (e.g. inter-cell mobility handover procedure), a handover procedure from a source MN PCell to a target SN PCell may be performed. In this case, an SN may be released. Information on MN SCell(s) may be included in a handover (HO) command (e.g. RRC reconfiguration message), but the UE may first perform an access procedure for the target SN PCell and then proceed with an access procedure for SCells. According to the above-described procedure, even if an SN is available, the SN may not be utilized. If the handover is performed after all SCells are released, the UP performance may be severely degraded momentarily. Additionally, DAPS may not support SCell(s).

In a mobility management method proposed in the present disclosure (e.g. inter-cell mobility LTM procedure), a target beam of a target cell (e.g. constituent target beam) may be designated, and the UE may be handed over after the target beam is designated. In this case, a beam alignment procedure can be omitted, allowing a cell switch procedure to be performed quickly. Even in a ping-pong situation, a beam switch procedure can be performed rapidly. In an environment where an SN is available, the SN may remain in use. Processing on SCell(s) may be performed in parallel rather than sequentially, enabling quick capacity provisioning. In a ping-pong situation, multiple pieces of prepared information may be shared between the UE and the network, allowing the cell switch procedure, path setup procedure according to the cell switch procedure, and/or path relocation procedure according to the cell switch procedure to be executed quickly based on minimal information. In the present disclosure, the network may refer to the base station depending on a context.

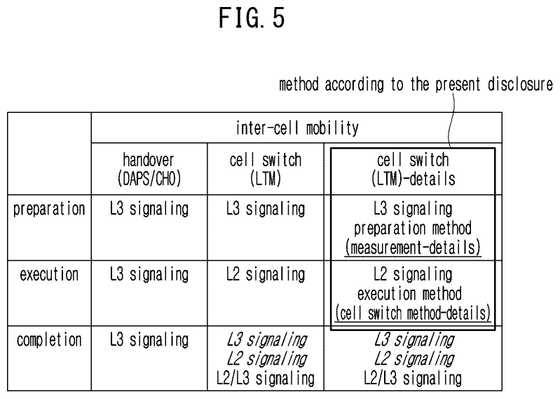

FIG. 5 is a conceptual diagram illustrating an inter-cell mobility procedure.

Referring to FIG. 5, an inter-cell mobility procedure may include three phases (e.g. preparation phase, execution phase, and completion phase). In the existing handover procedure (e.g. DAPS, conditional handover (CHO), etc.), all the phases may be performed using layer-3 (L3) signaling. In the LTM procedure disclosed herein, the preparation phase may be performed based on L3 signaling, the execution phase may be performed based on L2 signaling, and the completion phase may be performed based on L2/L3 signaling. Considering the DC state, methods for L1 measurement configuration during the preparation phase and/or cell switch procedures during the execution phase will be described.

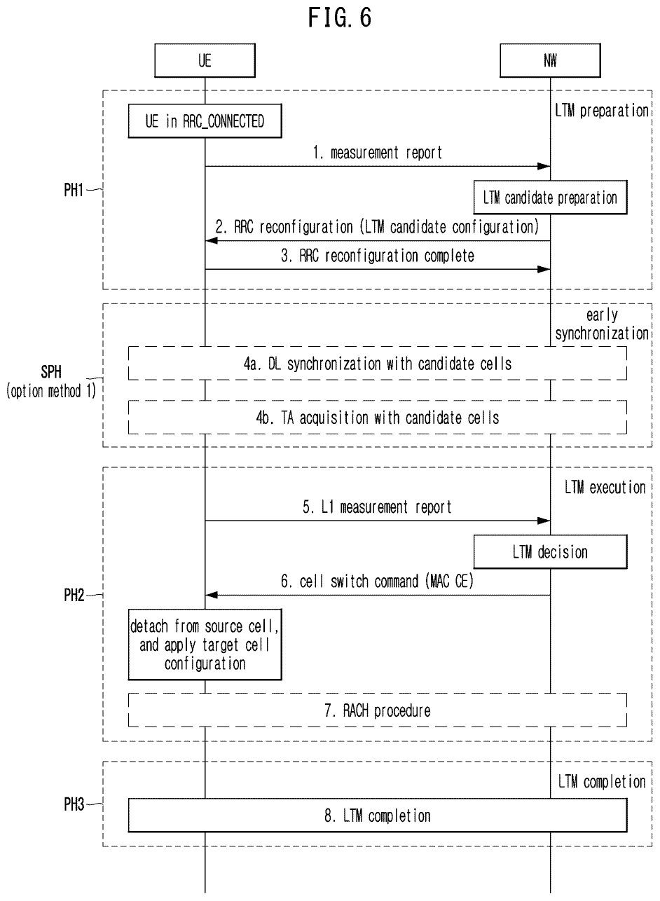

FIG. 6 is a sequence chart illustrating basic steps of an inter-cell mobility LTM procedure.

Referring to FIG. 6, a phase 1 (PH1) may indicate the preparation phase, a phase 2 (PH2) may indicate the execution phase, and a phase 3 (PH3) may indicate the completion phase. SPH may indicate a special phase, representing an early synchronization phase. In SPH, the early synchronization procedure may be performed based on an MN PCell and a list of multiple candidates for MN SCell(s) associated with the MN PCell, which are obtained in PH1. In other words, the early synchronization procedure may be performed for multiple candidate cells. In the early synchronization procedure, DL synchronization and/or UL synchronization procedures may be performed in advance. According to the early synchronization procedure, fast radio access may be achieved during a cell switch procedure. The early synchronization procedure may be performed based on a physical downlink control channel (PDCCH) order-based RACH procedure, RACH-less procedure, RACH procedure, and/or synchronization history. The synchronization history may be stored, allowing access based on the synchronization history without a new synchronization procedure in a ping-pong situation.

### PH1 (Preparation Phase)

A UE in the connected state (e.g. RRC connected state) may perform the preparation phase with the NW (network, e.g. a base station).

Measurement configuration for LTM candidate preparation based on certain policies/algorithms may be preconfigured by the NW to the UE. The NW may refer to a base station. The UE may periodically transmit (RRC) measurement reports to the NW based on the measurement configuration. Alternatively, when an event occurs, the UE may transmit a (RRC) measurement report to the NW. The (RRC) measurement report may serve as a condition for determining LTM candidates. Based on the UE's measurement reports, the NW may prepare the LTM candidates. The LTM candidates may include one or more target cells and/or one or more candidate beams for the one or more target cells. Once the LTM candidate preparation is complete, an RRC reconfiguration message (e.g. LTM candidate configuration information, L1 measurement configuration information) and an RRC reconfiguration complete message may be exchanged between the UE and the NW. For example, the NW may transmit the RRC reconfiguration message to the UE, and the UE may receive the RRC reconfiguration message from the NW. The UE may identify the information included in the RRC reconfiguration message (e.g. LTM candidate configuration information, L1 measurement configuration information). In response to the RRC reconfiguration message, the UE may transmit the RRC reconfiguration complete message to the NW, and the NW may receive the RRC reconfiguration complete message from the UE. Once the procedure for transmitting and receiving the RRC reconfiguration complete message is completed, the LTM preparation phase may be considered complete.

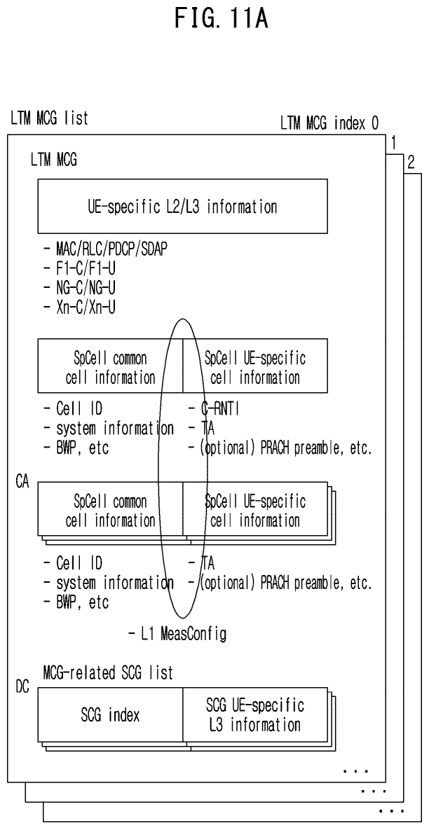

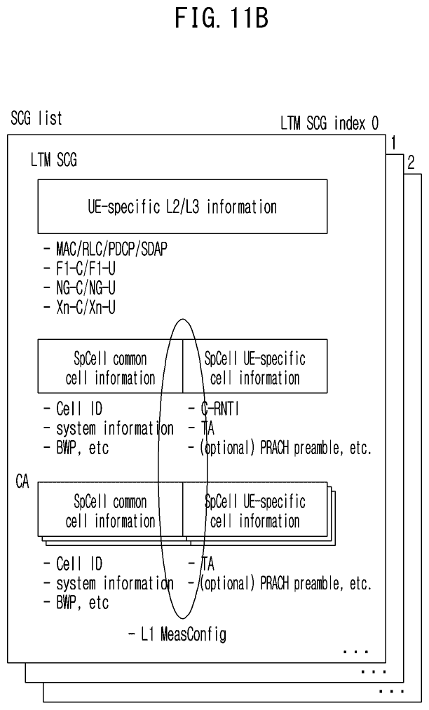

In the present disclosure, the LTM candidate configuration (e.g. L1 measurement configuration, such as L1MeasConfig) included in the RRC reconfiguration message will be described. The LTM candidate configuration may include an MCG list (e.g. LTM MCG list) shown in FIG. 11A and/or an SCG list (e.g. LTM SCG list) shown in FIG. 11B.

### SPH

DL synchronization procedures and/or UL synchronization procedures (e.g. timing advance (TA) acquisition procedures) for candidate cells indicated by the LTM candidate configuration included in the RRC reconfiguration message may be performed. SPH may be performed optionally. In other words, SPH may be omitted.

Synchronization information for a current serving PCell and SCell(s), as well as for a candidate PCell and candidate SCell(s), may be stored in communication node(s) (e.g. UE, network), and the stored synchronization information may be utilized.

Synchronization procedures for an MN PCell and MN SCell(s) in the candidate list, as well as for an SN PCell and SN SCell(s) in the candidate list, may be performed. The synchronization procedures for the MN PCell and MN SCell(s) in the candidate list may be performed first, followed by the synchronization procedures for the SN PCell and SN SCell(s) in the candidate list. Based on these synchronization procedures, a connection to the SN can be quickly established, and capacity recovery procedures due to UE mobility can proceed rapidly.

### PH2 (Execution Phase)

The UE may transmit an L1 measurement report to the NW based on the L1 measurement configuration (e.g. L1MeasConfig). The L1 measurement report may include L1 measurement results (e.g. L1 quality information) measured by the UE. The L1 measurement report may include measurement results for one or more candidate cells and/or one or more candidate beams indicated by the LTM candidate configuration. The NW may receive the L1 measurement report from the UE. The L1 measurement report may be included in a MAC CE, which is transmitted by the UE to the NW.

The NW may decide whether to perform the LTM procedure based on the L1 measurement report. The decision on whether to perform the LTM procedure may be made based on an inter-cell switch algorithm. If a preconfigured condition is satisfied, the LTM procedure may be determined to be performed. If LTM is decided (e.g. if the LTM procedure is determined to be performed), the NW may transmit a cell switch command to the UE using a beam of the corresponding cell. The cell switch command may be transmitted using a beam of a cell to be switched. The beam used to transmit the cell switch command may be a beam to be switched. The UE may receive the cell switch command from the NW. The cell switch command may be included in a MAC CE, which may be transmitted from the NW to the UE.

The UE may receive the cell switch command from the NW. The cell switch command may include information on a target cell which the UE is to access. Additionally, the cell switch command may include information on a beam of the target cell. Upon receiving the cell switch command, the UE may perform a cell switch procedure. For example, the UE may perform a detach procedure for the source cell and apply configuration of the target cell. The UE may perform a RACH procedure with the target cell. If a synchronization procedure between the UE and the target cell has already been completed, the UE may skip the RACH procedure. In other words, the RACH procedure may be omitted.

In the present disclosure, the L1 measurement reporting methods and/or the cell switch command will be described.

### PH3 (Completion Phase)

The LTM completion phase may be performed based on a MAC CE (i.e. L2 signal) and the RRC reconfiguration complete message (i.e. RRC signal). In the LTM completion phase, the MAC CE and the RRC reconfiguration complete message may be exchanged between the UE and the NW. Once the cell switch procedure from the source cell to the target cell is completed, the LTM completion procedure may be performed.

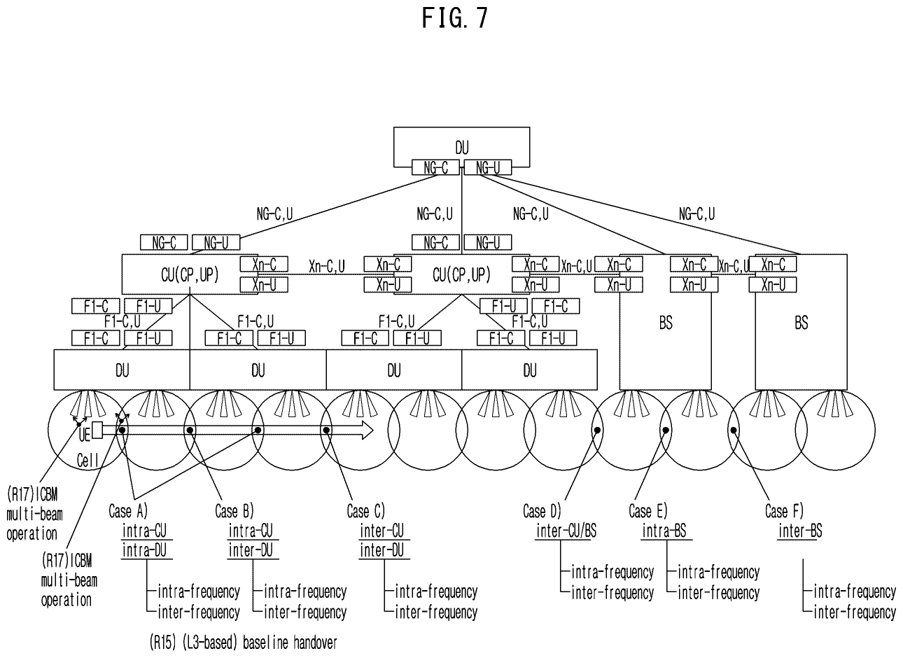

FIG. 7 is a conceptual diagram illustrating inter-cell mobility in various cases.

Referring to FIG. 7, cases may be classified as follows.
Case A: Intra-CU/Intra-DU cell switch
Case B: Intra-CU/Inter-DU cell switch
Case C: Inter-CU cell switch
Case D: Inter-CU/BS cell switch
Case E: Intra-BS cell switch
Case F: Inter-BS cell switch

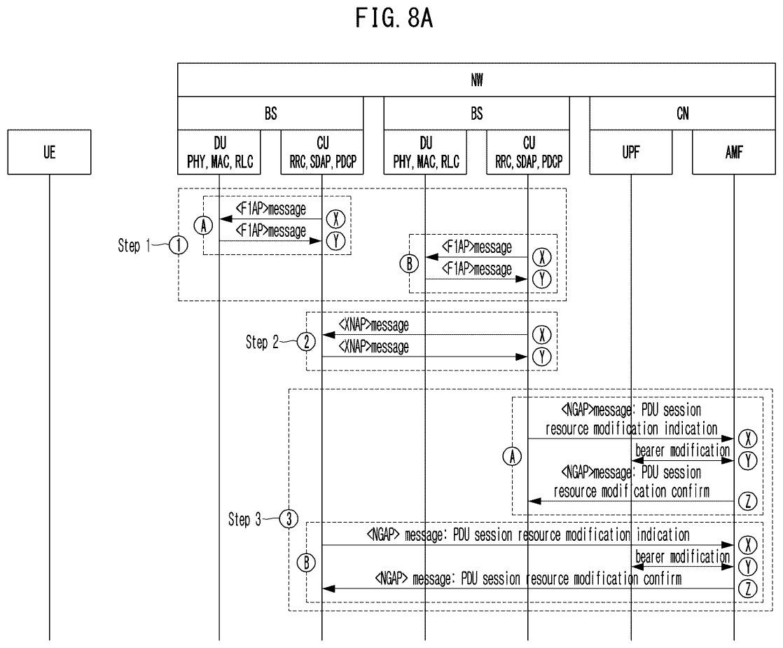

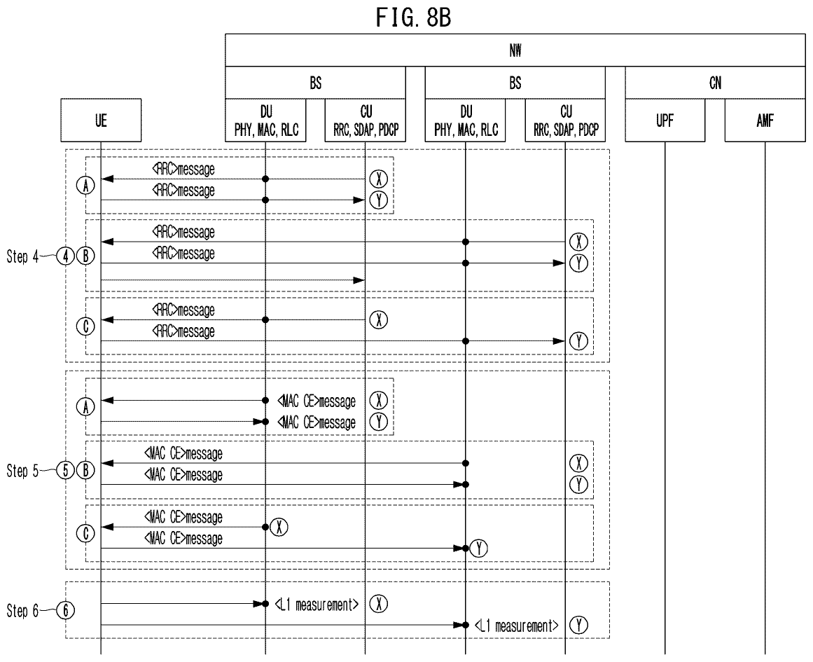

Inter-cell mobility may occur in various cases (e.g. Cases A, B, C, D, E, F). In such cases, signaling procedures may be performed using F1-C(F1AP) messages (e.g. messages in Step 1 of FIG. 8A), NG-C(NG-U) messages (e.g. messages in Step 3 of FIG. 8A), and/or XnAP (Xn-C) messages (e.g. messages in Step 2 of FIG. 8A). According to these signaling procedures, data paths of F1-U, NG-U, and Xn-U interfaces may be reconfigured in the UP. The base station (BS) may be split into a central unit (CU) and distributed unit(s) (DU(s)). The DU may include a PHY layer, MAC layer, and radio link control (RLC) layer. The CU may include an RRC layer, packet data convergence protocol (PDCP) layer, and service data application protocol (SDAP) layer.

FIGS. 8A and 8B are sequence charts illustrating signaling procedures between communication nodes.

Referring to FIGS. 8A and 8B, the exemplary embodiment in FIG. 8A may include Step 1, Step 2, and Step 3, while the exemplary embodiment in FIG. 8B may include Step 4, Step 5, and Step 6. The exemplary embodiment in FIG. 8B may be performed after the exemplary embodiment in FIG. 8A. In other words, Step 4 in FIG. 8B may be performed after Step 3 in FIG. 8A. The NW may include the BS and CN. The NW may be interpreted as the BS or CN depending on a context. The BS may include a CU and DU(s). The DU may support PHY functions, MAC functions, and RLC functions. The CU may support RRC functions, SDAP functions, and PDCP functions. The CN may include an UPF and AMF.

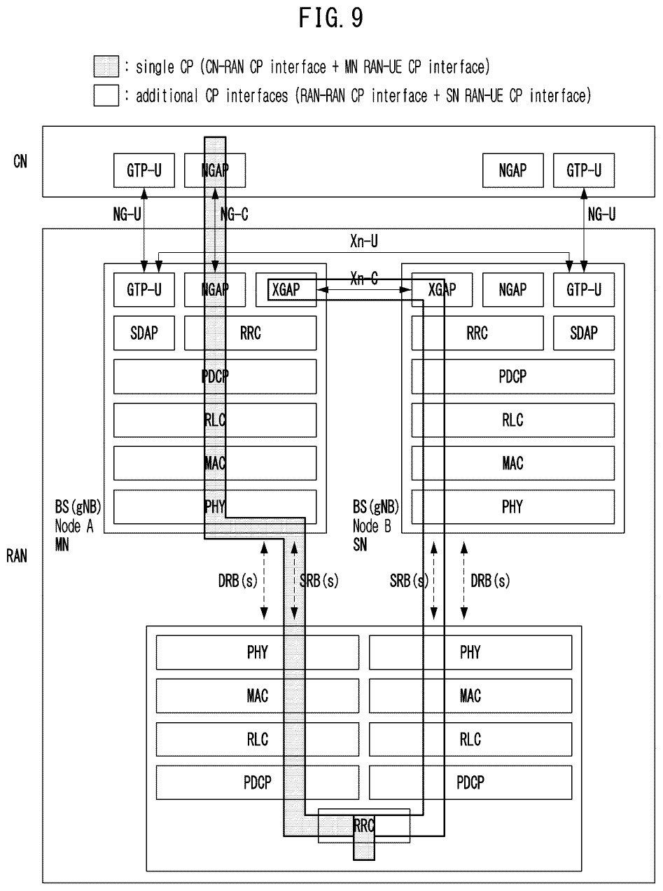

FIG. 9 is a conceptual diagram illustrating protocol stacks in the CP and UP.

Referring to FIG. 9, the protocol stacks in the CP and UP may correspond to the following case.

Case: Among the two BSs shown in FIG. 7, Node-A may act as an MN, while Node-B may act as an SN (e.g. DC environment).

A single CP for a connection CN-MN (Node A)-UE may exist. The MN Node-A may be connected to the SN Node-B through an XnAP (Xn-C) control interface. The SN Node-B may be connected to the UE through an RRC control interface. A connection between the CN and MN Node-A may be based on an NG-U (e.g. UP) interface, and this may indicate an MN-terminated state. A connection between the CN and SN Node-B may also be based on an NG-U (e.g. UP) interface, and this may indicate an SN-terminated state.

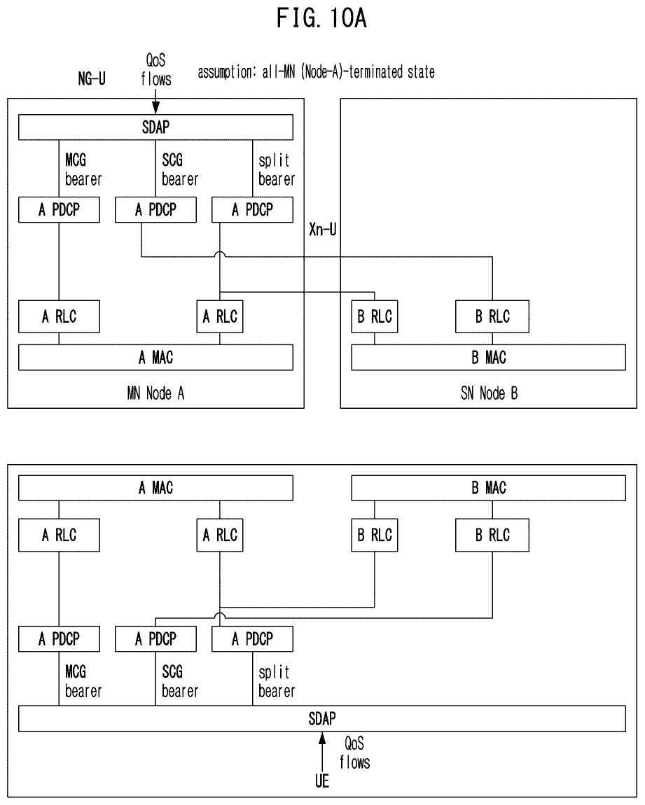

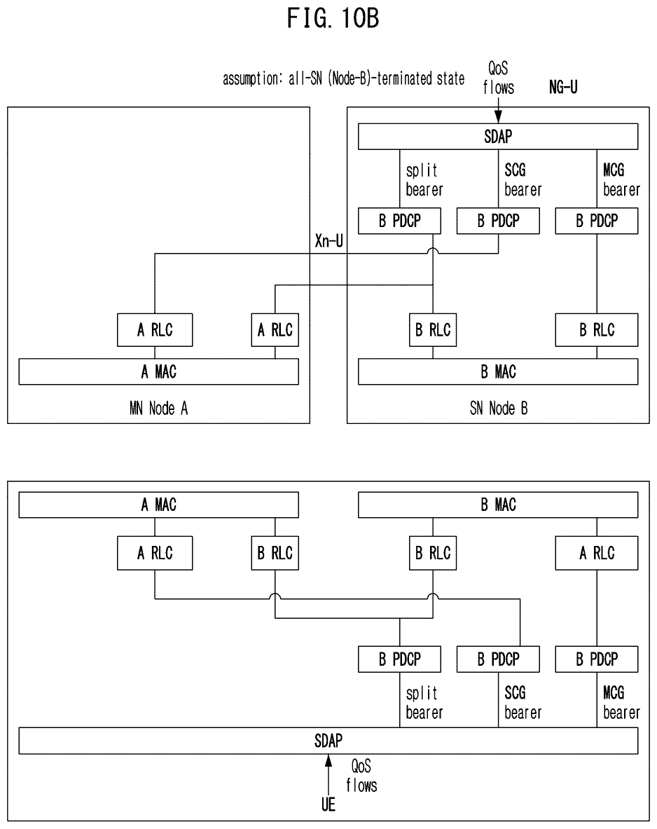

FIGS. 10A and 10B are conceptual diagrams illustrating bearer configurations in the UP.

Referring to FIGS. 10A and 10B, MCG bearers, SCG bearers, and/or split bearers may be configured in the UP. In the exemplary embodiment of FIG. 10A, the MCG bearers, SCG bearers, and split bearers may all terminate at the CN-MN (i.e. Node-A). In other words, the exemplary embodiment in FIG. 10A may represent an all-MN-terminated state. In the exemplary embodiment of FIG. 10B, the MCG bearers, SCG bearers, and split bearers may all terminate at the CN-SN (i.e. Node-B). In other words, the exemplary embodiment in FIG. 10B may represent an all-SN-terminated state. Some MCG bearers (or SCG bearers, split bearers) may be in the MN-terminated state, while others may be in the SN-terminated state.

FIG. 11A is a conceptual diagram illustrating an LTM MCG list, and FIG. 11B is a conceptual diagram illustrating an SCG list.

Referring to FIGS. 11A and 11B, the LTM candidate configuration in PH1 (e.g. the LTM preparation phase) of FIG. 6 may be managed in form of information shown in FIGS. 11A and 11B. In other words, the LTM candidate configuration may include an LTM MCG list in FIG. 11A and/or an SCG list (e.g. LTM SCG list) in FIG. 11B. In the exemplary embodiment of FIG. 11A, the LTM MCG list may be used to manage an MCG to which the UE is currently connected and candidate MCG(s) to which the UE may connect in the future (e.g. candidate cell(s) belonging to the MCG(s)). The MCG list may include information on one or more candidate cells (e.g. one or more candidate MCGs). LTM MCG (e.g. LTM MCG information) may include UE-specific L2/L3 information for the UE. The UE-specific L2/L3 information may include MAC information, RLC information, PDCP information, SDAP information, F1-C information, F1-U information, NG-C information, NG-U information, Xn-C information, and/or Xn-U information. The F1-C/F1-U information may correspond to information in a DU-CU structure of the NW. The NG-C/NG-U information may correspond to information on CN-BS. The Xn-C/Xn-U information may correspond to information on BS-BS. The MCG list may include an MCG-related SCG list, and the MCG-related SCG list may include a list of SCG(s) associated with the MCG. For example, the MCG-related SCG list may include at least one of SCG index(es) or SCG UE-specific L3 information.

Common cell information and UE-specific cell information for a PCell (e.g. SpCell) may be managed. Based on CA, SCell(s) associated with the PCell (e.g. SpCell) may exist, and common cell information and UE-specific cell information for each SCell may also exist. L1 measurement information (e.g. L1MeasConfig) for the PCell and SCell(s) may be included. The L1 measurement information may serve as a transmission criterion (e.g. transmission condition, triggering condition) for the L1 measurement report in PH2 of FIG. 6 (e.g. the LTM execution phase). A unique MCG index (e.g. 0, 1, 2, etc.) for each MCG included in the MCG list may be defined.

Similarly to the management of the MCG information list, one piece of MCG information may be associated with one or more pieces of SCG information. The one or more pieces of SCG information may be managed based on one or more SCG indexes associated with one MCG information through DC and may also be managed based on L3 information (e.g. MN termination information, SN termination information, and Xn-C/Xn-U information between the MCG and SCG) for the MCG corresponding to the one or more SCG indexes.

In the exemplary embodiment of FIG. 11B, an SCG list (e.g. LTM SCG list) may be used to manage an SCG to which the UE is currently connected and candidate SCG(s) (e.g. candidate cell(s) belonging to the SCG(s)) to which the UE may connect in the future. The SCG list may include information on one or more candidate cells (e.g. one or more candidate SCGs). LTM SCG (e.g. LTM SCG information) may include UE-specific L2/L3 information for the UE. The UE-specific L2/L3 information may include MAC information, RLC information, PDCP information, SDAP information, F1-C information, F1-U information, NG-C information, NG-U information, Xn-C information, and/or Xn-U information. The F1-C/F1-U information may be information in the DU-CU structure of the NW. The NG-C/NG-U information may be information on CN-BS. The Xn-C/Xn-U information may be information on BS-BS.

Common cell information and UE-specific cell information for a PSCell (e.g. SpCell) may be managed. Based on CA, SCell(s) associated with the PSCell (e.g. SpCell) may exist, and common cell information and UE-specific cell information for each SCell may also exist. L1 measurement information (e.g. L1MeasConfig) for the PSCell and SCell(s) may be included. The L1 measurement information may serve as a transmission criterion (e.g. transmission condition, triggering condition) for the L1 measurement report in PH2 of FIG. 6 (e.g. LTM execution phase). A unique SCG index (e.g. 0, 1, 2, etc.) for each SCG included in the SCG list may be defined.

In PH1 of FIG. 6 (e.g. the LTM preparation stage), the UE may receive the RRC reconfiguration message from the NW (e.g. base station). The RRC reconfiguration message may include LTM candidate configuration, which may include at least one of information on the LTM MCG list of FIG. 11A or information on the SCG list (e.g. LTM SCG list) of FIG. 11B. Among these information, information excluding information related to the NW (e.g. NG-C/NG-U, Xn-C/Xn-U, and F1-C/F1-U in the CU-DU structure) may be shared. On the NW side, the LTM MCG list of FIG. 11A and/or the SCG list of FIG. 11B may be shared among CUs in Case C of FIG. 7, along with the NW information required in the structure of Case C. In Case D of FIG. 7, the LTM MCG list of FIG. 11A and/or the SCG list of FIG. 11B may be shared between the CU and BS, along with the NW information required in the structure of Case D. In Case F of FIG. 7, the LTM MCG list of FIG. 11A and/or the SCG list of FIG. 11B may be shared among BSs, along with the NW information required in the structure of Case F.

Through the sharing of the above-described information, the currently serving MCG and SCG(s) associated with the serving MCG may be identified. Once the serving MCG and the SCG(s) are identified, a cell switch command may be transmitted. Until the cell switch procedure is complete, the NW may identify the nodes (e.g. communication nodes) connected to the CN in the current structure through the CP and UP, data being forwarded among the nodes, and the like. The UE may identify the serving MCG for the CP and UP, the SCG(s) associated with the serving MCG, and a scheme of handling existing data during the cell switch procedure (e.g. internal processing scheme). By indexing the above-described information, the amount of information for the L1 measurement report and the cell switch command in PH2 of FIG. 6 may be reduced.

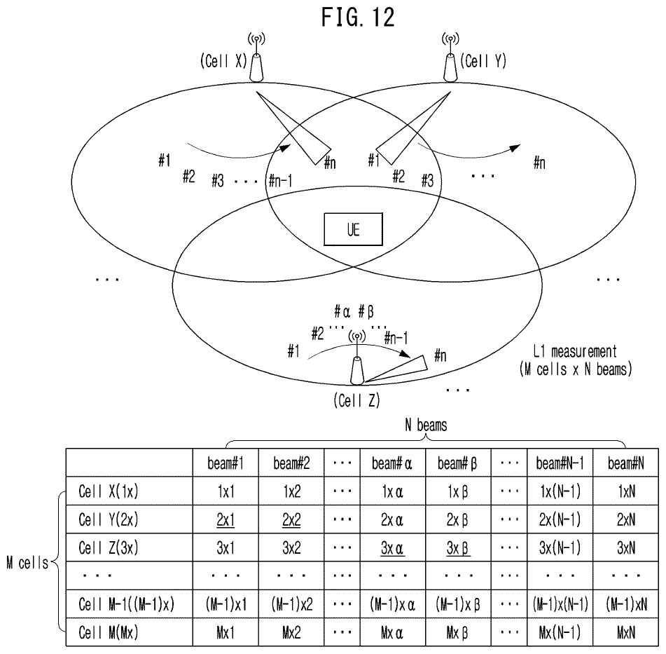

For the cell switch procedure in the various cases (e.g. Cases A, B, C, D, E, and F) shown in FIG. 7, a subsequent procedure at the NW shown in FIG. 8 may be necessary, instead of the basic LTM procedure shown in FIG. 6. An L1 measurement configuration scheme for one MCG in FIG. 11A and/or an L1 measurement configuration scheme for SCG(s) associated with the MCG in FIG. 11B will be described with reference to FIG. 12.

FIG. 12 is a conceptual diagram illustrating an L1 measurement configuration scheme.

Referring to FIG. 12, the UE may perform measurements on all beams of the serving PCell and determine a quality of the serving PCell based on an average value of measurement results. The UE may also perform measurements on all beams of candidate PCell(s) (e.g. PCell(s) which the UE is able to access) and determine a quality (e.g. beam quality) of each of the candidate PCell(s) based on an average value of measurement results for each of the candidate PCell(s). The candidate PCell(s) may refer to candidate cell(s). Beam switching through beam measurements may occur at the serving PCell. The UE may be located in a boundary region between the serving PCell and a candidate PCell. The UE may perform beam measurements on the candidate PCell and determine a quality of the candidate PCell based on an average value of beam measurement results.

In the present disclosure, L1 measurement configurations for the serving MCG PCell and candidate MCG PCell(s) for LTM, as well as for MCG SCell(s), SCG PSCell, and/or SCG SCell(s), will be described. Measurement procedures (e.g. measurement operations) may impose significant burdens on the UE. Various L1 measurement configurations may be configured. Certain conditions may be assigned, and priorities for the certain conditions may also be assigned. Based on the certain conditions and/or the priorities, the burden on the beam measurement procedures and/or cell measurement procedures may be alleviated. Consequently, the LTM procedure can be performed quickly.

In the exemplary embodiment of FIG. 12, three MCG PCells (e.g. Cell X, Cell Y, and Cell Z) may exist, and MCG SCell(s) associated with each MCG PCell may also exist. M×N instances for the entire measurement may exist, where M may represent the number of cells, and N may represent the number of beams in each cell. In this case, M×N instances (e.g. beam measurement instances) for L1 measurement configuration may exist. The UE may be located in a boundary region of Cells X, Y, and Z. In this case, 3×N MCG PCell instances for the UE may exist.

SCell information (e.g. SCell common information, SCell UE-specific information) for SCell(s) associated with a PCell based on CA may be included in one piece of MCG information (e.g. LTM MCG information shown in FIG. 11A). The SCell information for SCell(s) may also be included in the L1 measurement configuration (e.g. L1 measurement configuration information). The L1 measurement configuration may be represented by M×N beam measurement instances. Due to measurement operations for not only the serving cell but also the candidate cell(s), the burden on the UE may increase. A significant amount of time and/or energy may be required for all beam measurement instances for the PCell, SCell(s), and/or candidate cells.

Measurements related to beam(s) belonging to the current MCG PCell and measurements related to beam(s) belonging to candidate MCG PCell(s) may have the highest priority. In a cell deployment (CD) type 2, maintaining beam measurements on the SN may be required. In the inter-cell mobility handover procedure, a cell radio measurement value may be determined based on an average of measurement values for all beams of the cell, and whether to perform the inter-cell mobility handover procedure may be determined based on the cell radio measurement value (e.g. average cell measurement value).

In the inter-cell mobility LTM procedure, current beam measurements may be more important than the average cell measurement value in the boundary region of cells. If an optimal beam exists, beam measurement procedures for beam(s) belonging to a cell with the optimal beam and/or beam(s) belonging to cells other than the cell with the optimal beam may be performed. In the inter-cell mobility LTM procedure, L1 measurement configuration instances (e.g. beam measurement instances) may be configured as shown in a table in FIG. 12. Beam(s) affecting at cell boundary (e.g. beam measurement instance(s) underlined in the table of FIG. 12) may be defined. The NW (e.g. base station) may inform the UE of information on the beam(s) affecting at the cell boundary. In other words, the NW (e.g. base station) may instruct the UE to prioritize measurements on the beam(s) affecting at the cell boundary. Information on the beam(s) affecting at the cell boundary may be included in the L1 measurement configuration (e.g. L1 measurement configuration information). In other words, the L1 measurement configuration may include information on beam measurement instances affecting at the cell boundary. The UE may prioritize measurements for the beam(s) affecting at the cell boundary based on the instruction of the NW.

The L1 measurement configuration may include beam measurement instance(s) with high priority. Alternatively, when the L1 measurement configuration includes multiple beam measurement instances, the UE may perform measurements on beam measurement instances with high priority among the multiple beam measurement instances. In this case, measurement operations for beam measurement instances with low priority may be omitted. The beam measurement instances with high priority may be determined based on preconfigured conditions and/or rules.

The beam measurement instances at the cell boundary may be defined based on a preconfigured CD. Alternatively, the beam measurement instances at the cell boundary may be defined based on information obtained from network operations. Among M×N beam measurement instances (e.g. beam measurement instances for the MCG PCell), the most important beam measurement instance(s) may be determined. The UE may perform measurement on the most important beam measurement instance(s). When the most important beam measurement instance(s) are determined, the L1 measurement burden on the UE may be reduced. Furthermore, information on the most important beam measurement instance(s) among the beam measurement instances for the SCell(s) associated with the MCG PCell may be provided to the UE. The UE may perform measurements on the most important beam measurement instance(s) indicated by the NW.

The beam measurement instances for the MCG PCell may be prioritized, and beam measurement instances for the SCell(s) associated with the MCG PCell based on CA may have low priority. When beam measurement instances are restricted (e.g. specified), restricted (e.g. specified) beam measurement instances for the MCG SCell(s) may have higher priority than unrestricted (e.g. unspecified) beam measurement instances for the MCG PCell. The L1 measurement information may include information on the restricted beam measurement instances. In PH2 of FIG. 6, the L1 measurement report may be transmitted based on the restricted beam measurement instances. In other words, whether to perform the LTM execution procedure may be determined based on the restricted beam measurement instances (e.g. measurement results for the restricted beam measurement instances). The UE may perform measurements on the restricted beam measurement instances (e.g., beam measurement instances with high priority).

The LTM MCG list (e.g. L1 measurement configuration) shown in FIG. 11A and the SCG list (e.g. L1 measurement configuration) shown in FIG. 11B may be applied to the exemplary embodiment of FIG. 12. In FIG. 12, all nodes may be SN nodes, and beam measurement instances for the SNs may be defined. Cell X, Cell Y, and Cell Z may be PSCells of the SNs, and each PSCell may operate one or more beams. Beam measurement instances for SCell(s) associated with each PSCell based on CA may exist. Beam measurement instances for the SCG PSCell may be prioritized, while beam measurement instances for SCell(s) associated with the SCG PSCell based on CA may have low priority. When beam measurement instances are restricted (e.g. specified), restricted (e.g. specified) beam measurement instances for the SCG SCell(s) may have higher priority than unrestricted (e.g. unspecified) beam measurement instances for the SCG PSCell.

In a form identical or similar to the table shown in FIG. 12, a table for beam measurement instances for the MN PCell and MN SCell(s) associated with the MN PCell, as well as a table for beam measurement instances for the SN PSCell and SN SCell(s) associated with the SN PSCell, may exist. In certain cases, a priority of beam measurement instances for the SN PSCell may be higher than a priority of beam measurement instances for the MN PCell.

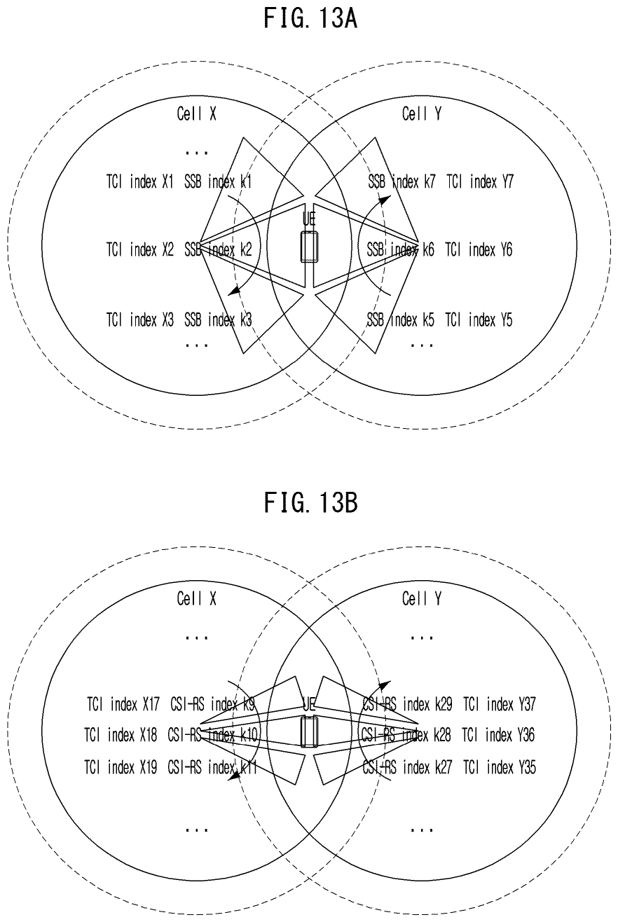

FIGS. 13A and 13B are conceptual diagrams illustrating beam indexes.

Referring to FIGS. 13A and 13B, a transmission configuration indicator (TCI) index, synchronization signal block (SSB) index, and/or channel state information-reference signal (CSI-RS) index may be used to indicate a beam. In other words, a TCI index, SSB index, and/or CSI-RS index may serve as a beam index. In the exemplary embodiment of FIG. 13A, an SSB index may be defined based on PCell (SpCell) common cell information for one MCG in the LTM MCG list shown in FIG. 11A, MN SCell common cell information for MN SCell(s) associated with the PCell based on CA, PSCell (SpCell) common cell information for one SCG in the SCG list shown in FIG. 11B, and/or SN SCell common cell information for SN SCell(s) associated with the PSCell based on CA. The SSB index may be common information. The UE may acquire the SSB index through a broadcast channel even if the UE is not connected to the BS. During the preparation phase of the inter-cell mobility procedure (e.g. handover procedure, LTM procedure), the UE may acquire information on candidate cell(s) through a dedicated channel. A beam corresponding to the SSB index may have a wider beamwidth than a beam corresponding to a CSI-RS index. SSB beam sweeping may be referred to as coarse beam sweeping.

In the exemplary embodiment of FIG. 13B, a CSI-RS index may be defined based on PCell (SpCell) UE-specific cell information for one MCG in the LTM MCG list shown in FIG. 11A, MN SCell UE-specific cell information for MN SCell(s) associated with the PCell based on CA, PSCell (SpCell) UE-specific cell information for one SCG in the SCG list shown in FIG. 11B, and/or SN SCell UE-specific cell information for SN SCell(s) associated with the PSCell based on CA. The CSI-RS index may be UE-specific information. A UE in the RRC connected state may acquire the CSI-RS index through a dedicated channel. During the preparation phase of the inter-cell mobility procedure (e.g. handover procedure, LTM procedure), the UE may obtain information on candidate cell(s) through a dedicated channel. A beam corresponding to the CSI-RS index may have a narrower beamwidth than a beam corresponding to an SSB index. CSI-RS beam sweeping may be referred to as fine beam sweeping.

In the exemplary embodiments of FIGS. 13A and 13B, beams may be defined such that a unique TCI index is assigned for an SSB index and a CSI-RS index within two PCells (or two PSCells). If a unique SSB index or unique CSI-RS index exists for each cell (e.g. within each cell) with two PCells (or two PSCells) considering inter-cell mobility, an L1 measurement report and/or cell switch command may include a cell identifier (ID), a flag indicating a unique SSB index or unique CSI-RS index, and a beam index for a beam to which the UE is to switch. When a TCI index (e.g. TCI index associated with an SSB index or CSI-RS index) is used, since all beams (e.g. beams corresponding to SSB indexes and beams corresponding to CSI-RS indexes) in the current serving cell and/or candidate cell(s) are uniquely defined, it may be possible for the L1 measurement report and/or cell switch command to include only information of the TCI index.

Considering the exemplary embodiments of FIGS. 13A and 13B, in a form identical or similar to the table of FIG. 12, a table for beam measurement instances for a case where an SSB index is used as a beam index, and a table for beam measurement instances for a case where a CSI-RS index is used as beam index may exist. The TCI indexes may replace some or all of beam measurement indexes in these two tables. The beam indexes (e.g. beam measurement instances) may be uniquely numbered based on the TCI indexes. Tables 1, 2, and 3 below each may represent beam indexes.

TABLE 1

| Cell X | Cell Y |
|---|---|
| SSB index | SSB index |
| 1 | 1 |
| 2 | 2 |
| 3 | 3 |
| 4 | 4 |
| 5 | 5 |
| 6 | 6 |
| 7 | 7 |
| 8 | 8 |
| 9 | 9 |

TABLE 2

| Cell X | Cell Y |
|---|---|
| CSI-RS index | CSI-RS index |
| 1 | 1 |
| 2 | 2 |
| 3 | 3 |
| 4 | 4 |
| 5 | 5 |
| 6 | 6 |
| 7 | 7 |
| 8 | 8 |
| 9 | 9 |
| 10 | 10 |
| 11 | 11 |
| 12 | 12 |
| 13 | 13 |
| 14 | 14 |
| 15 | 15 |
| 16 | 16 |
| 17 | 17 |
| 18 | 18 |
| 19 | 19 |
| 20 | 20 |
| 21 | 21 |
| 22 | 22 |
| 23 | 23 |
| 24 | 24 |
| 25 | 25 |
| 26 | 26 |
| 27 | 27 |

TABLE 3
Cell X/Cell Y
TCI index

1
2
3
4
5
6
7
8
9
10
11
12
13
14
15
16
17
18
19
20
21
22
23
24
25
26
27
28
29
30
31
32
33
34
35
36
37
38
39
40
41
42
43
44
45
46
47
48
49
50
51
52
53
54
55
56
57
58
59
60
61
62
63
64
65
66
67
68
69
70
71
72

Table 1 may represent SSB indexes. The UE and NW may identify an SSB index through a broadcast channel or a dedicated channel during the inter-cell mobility handover/LTM procedure. The SSB indexes may be unique per cell. Table 2 may represent CSI-RS indexes. The UE and NW may identify a CSI-RS index through a dedicated channel during the inter-cell mobility handover/LTM procedure. The CSI-RS indexes may be unique per cell. The number of CSI-RS indexes may be greater than the number of SSB indexes. Table 3 may represent TCI indexes. Considering two cells (e.g. the serving cell and candidate cell) and 36 beam indexes (e.g. 9 SSB indexes from Table 1+27 CSI-RS indexes from Table 2), there may be 72 TCI indexes.

If new TCI indexes (e.g. TCIEnh indexes) are defined, the TCI indexes may not be uniquely numbered considering all SSB indexes and CSI-RS indexes for the current serving cell and candidate PCell(s). The table in FIG. 12 may be generated for SSB indexes and/or CSI-RS indexes. For the serving PCell and candidate PCell(s), grouping of SSB indexes and CSI-RS indexes considering only beams underlined in the table of FIG. 12 (e.g. beam indexes corresponding the boundary region) may be performed. For the grouped indexes, the new TCI indexes may be numbered to ensure unique beam measurement instances.

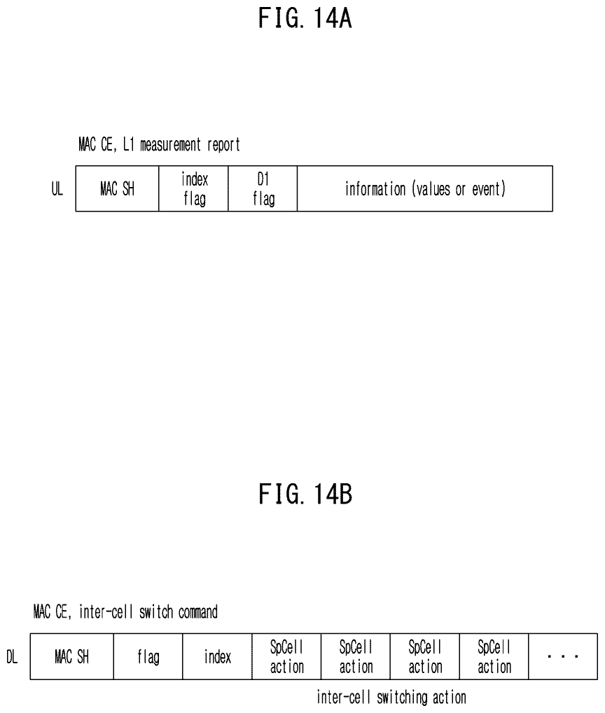

FIG. 14A is a block diagram illustrating a MAC CE for L1 measurement reporting in PH2 of FIG. 6.

Referring to FIG. 14A, an L1 measurement report may be an uplink (UL) message. The L1 measurement report may include at least one of a MAC sub-header (SH) (e.g. MAC header), index flag field, D1 flag field, or information field. A reserved field included in the MAC SH may indicate that the corresponding message (e.g. UL message) is an L1 measurement report. The index flag (e.g. index flag field) may be set as shown in Table 4 below. The index flag may indicate an SSB index, CSI-RS index, TCI index, or TCIEnh index. The index flag may include information (e.g. SSB index, CSI-RS index, TCI index, or TCIEnh index) on a beam measured by the UE or a target beam of the UE. The target beam of the UE may be a target beam for the beam switch operation. The beam indicated by the index flag may correspond to a beam of a cell associated with the cell ID included in the information field.

TABLE 4
Index flag

| | |
|---|---|
| 000 | SSB index |
| 001 | CSI-RS index |
| 010 | TCI index |
| 011 | TCIEnh index |
| . . . | Reserved |
| 111 | Reserved |

The D1 flag (e.g. D1 flag field) may be set as shown in Table 5 below. The D1 flag may indicate whether the L1 measurement value represents a reference signal received power (RSRP) value or an event defined by the L1 measurement configuration (e.g. E1, E2, E3, E4, or the like). The D1 flag may refer to a triggering condition for transmission of the L1 measurement report. For example, when the L1 measurement report is transmitted upon satisfying an RSRP threshold, the D1 flag in the report may indicate a specific value (e.g. 00). When the report is transmitted upon satisfying an event, the D1 flag may indicate the corresponding event (e.g. 01).

TABLE 5
D1 flag

| | |
|---|---|
| 00 | Values (e.g. RSRP values) |
| 01 | Event |
| 10 | Reserved |
| 11 | Reserved |

If the D1 flag indicates ‘values’ and the index flag indicates an SSB index, the information field may indicate a cell ID (e.g. 8 bits or 16 bits), SSB index (e.g. 4 bits or more), and RSRP L1 measurement value (e.g. 7 bits or more). If the D1 flag indicates ‘values’ and the index flag indicates a CSI-RS index, the information field may indicate a cell ID (e.g. 8 bits or 16 bits), CSI-RS index (e.g. 8 bits or more), and RSRP L1 measurement value (e.g. 7 bits or more). If the D1 flag indicates ‘values’ and the index flag indicates a TCI index, the information field may indicate a TCI index (e.g. 8 bits or more) and RSRP L1 measurement value (e.g. 7 bits or more). If the D1 flag indicates ‘values’ and the index flag indicates a TCIEnh index, the information field may indicate a TCIEnh index (e.g. 8 bits or more) and RSRP L1 measurement value (e.g. 7 bits or more).

If the D1 flag indicates ‘event’ and the index flag indicates an SSB index, the information field may indicate a cell ID (e.g. 8 bits or 16 bits), SSB index (e.g. 4 bits or more), and event. If the D1 flag indicates ‘event’ and the index flag indicates a CSI-RS index, the information field may indicate a cell ID (e.g. 8 bits or 16 bits), CSI-RS index (e.g. 8 bits or more), and event. If the D1 flag indicates ‘event’ and the index flag indicates a TCI index, the information field may indicate a TCI index (e.g. 8 bits or more) and event. If the D1 flag indicates ‘event’ and the index flag indicates a TCIEnh index, the information field may indicate a TCIEnh index (e.g. 8 bits or more) and event.

The events may be predefined by the L1 measurement configuration. The events may be defined as shown in Table 6 below, where a single value from Table 6 may be included in the information field.

TABLE 6
Events (3 bits or more)

| | |
|---|---|
| 000 | E1-A |
| 001 | E1-B |
| 010 | E2-A |
| 011 | E2-B |
| . . . | Reserved |
| 111 | Reserved |

The E1-A event may indicate that a measurement value for a beam measurement instance of a candidate cell is higher than a predefined RSRP threshold (or RSRQ threshold). The E1-B event may indicate that a measurement value for a beam measurement instance of a candidate cell is lower than a predefined RSRP threshold (or RSRQ threshold). The E2-A event may indicate that a measurement value for a beam measurement instance of a candidate cell is higher than a measurement value for a beam measurement instance of the current serving cell. The E2-B event may indicate that a measurement value for a beam measurement instance of a candidate cell is lower than a measurement value for a beam measurement instance of the current serving cell.

FIG. 14B is a block diagram illustrating a MAC CE for a cell switch command in PH2 of FIG. 6.

Referring to FIG. 14B, a cell switch command (e.g. inter-cell switch command) may be a downlink (DL) message. The cell switch command may include at least one of a MAC SH (e.g. MAC header), flag field, index field, or SpCell action field(s). A reserved field included in the MAC SH may indicate that the corresponding message (e.g. DL message) is a cell switch command (e.g. inter-cell switch command). A unified index for an MCG index and SCG index shown in FIGS. 11A and 11B may be defined. Using various information related to the unified index and information shared between the NW and UE (e.g. the information shown in FIGS. 11A and 11B), an MCG-centric inter-cell switch operation may be performed based on the MCG index and SCG index. An SCG-centric inter-cell switch operation may be performed consecutively after the MCG-centric inter-cell switch operation. The MCG may remain unchanged, and only the SCG-centric inter-cell switch operation may be performed. Similarly, the SCG may remain unchanged, and only the MCG-centric inter-cell switch operation may be performed.

The flag (e.g. flag field) may indicate whether a target (TGT) to which the UE is to move is an MCG-centric target or SCG-centric target. In other words, the flag may indicate a type of a cell group (CG) (e.g. MCG or SCG) which the UE is to access. The index (e.g. index field) may indicate an MCG index or SCG index for the target to which the UE is to move. In other words, if the flag indicates ‘MCG’, the index may indicate an index for an MCG. If the flag indicates ‘SCG’, the index may indicate an index for an SCG. The MCG index may be associated with the MCG list (e.g. LTM MCG list) shown in FIG. 11A. The SCG index may be associated with the SCG list (e.g., LTM SCG list) shown in FIG. 11B.

The MAC CE for the cell switch command may include one or more SpCell action fields. Each of the one or more SpCell action fields may indicate deactivation or activation. For example, an SpCell action field set to 000 may indicate deactivation of the corresponding SpCell, while an SpCell action field set to 001 may indicate activation of the corresponding SpCell.

Whether the UE is to move to the SpCell and/or SCell(s) may be determined based on an order defined in the information for the MCG index or SCG index. The SpCell in the MCG may be the PCell. In other words, in the LTM procedure, whether the UE is to move to the target SpCell or SCell(s) may be determined. The SpCell in the SCG may be the PSCell. The SCell(s) in the MCG may be MN SCell(s). The SCell(s) in the SCG may be SN SCell(s). During the LTM candidate configuration in PH1 (e.g. LTM preparation phase) of FIG. 6, the information shown in FIGS. 11A and 11B may be defined using fields for the MCG index and SCG index. The UE and NW may share this information (e.g. LTM candidate configuration). The cell switch command may be generated based on the MCG index or SCG index. In other words, the cell switch command may include the index for the target MCG or the index for the target SCG. This may simplify the cell switch command.

Before the NW transmits the LTM candidate configuration to the UE in PH1 (e.g. LTM preparation phase) of FIG. 6, network connection information may be shared among entities (e.g. BS-BS, DU-CU, CU-CU, CU-BS) within the NW(s) (e.g. separated NWs), enabling smooth subsequent operations for the cell switch procedure. In various NW architectures shown in FIG. 7, network connection information may be shared among entities (e.g. BS-BS, DU-CU, CU-CU, CU-BS) within the NW(s) (e.g. separated NWs) through the steps (e.g., Step 1, Step 2, Step 3, etc.) shown in FIGS. 8A and 8B, enabling smooth subsequent operations for the cell switch procedure.

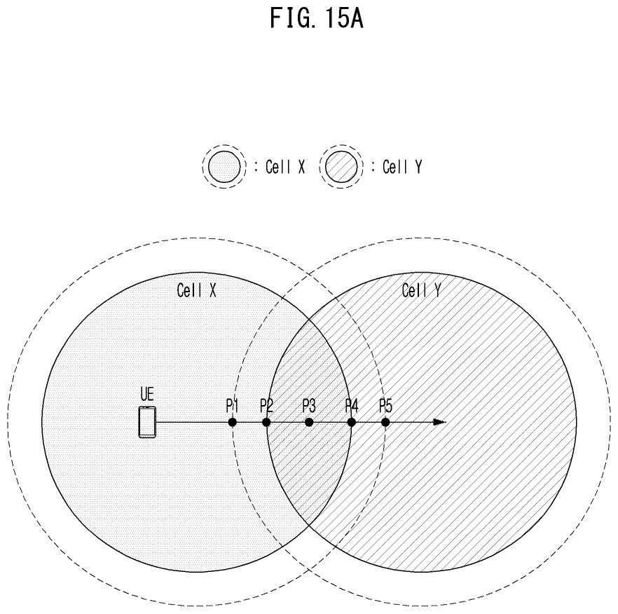

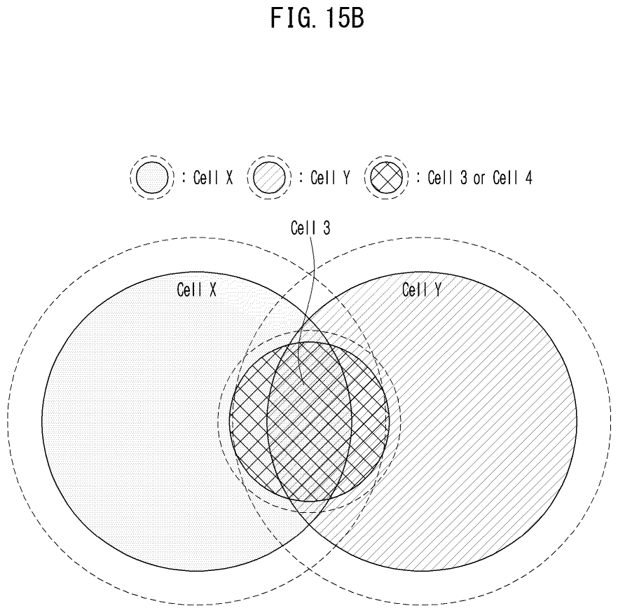

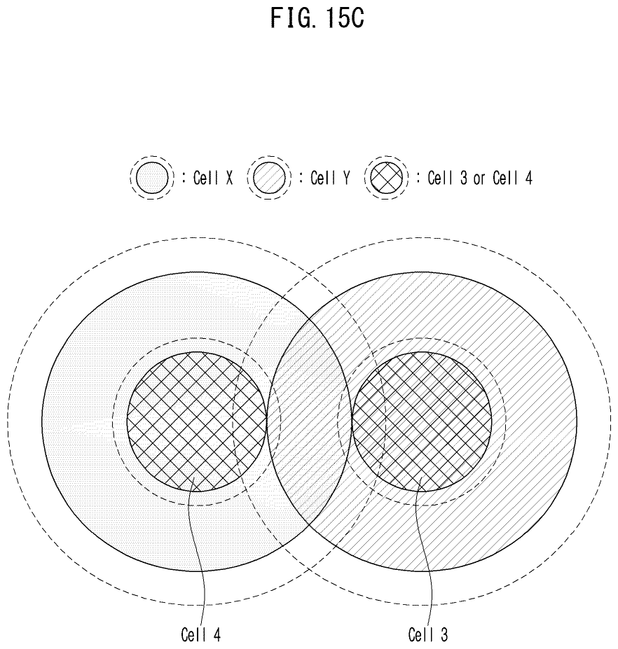

FIGS. 15A, 15B, and 15C are conceptual diagrams illustrating a communication system that includes two cells.

Referring to FIGS. 15A, 15B, and 15C, two MCG PCells (e.g. MN Cell X and MN Cell Y) may be configured. Cells 3 and 4 may be SN cells. In the exemplary embodiment of FIG. 15A, a UE located in MCG PCell X (e.g. Cell X) may move to a candidate cell, MCG PCell Y (e.g. Cell Y). In the exemplary embodiment of FIG. 15B, SN Cell 3 may be located in a boundary region between Cell X and Cell Y In the exemplary embodiment of FIG. 15C, SN Cell 4 may be located within Cell X, and SN Cell 3 may be located within Cell Y In the exemplary embodiment of FIG. 15B, SN Cell 3 may be reused, and the NW may partially modify a data path if needed, thereby supporting utilization of Cell 3's capacity.

Considering the cell deployment scenarios illustrated in FIGS. 15A, 15B, and 15C and the various network architecture scenarios shown in FIG. 7 (e.g. Case A, Case B, Case C, Case F), the scenarios may be further classified. The cell deployment scenario in FIG. 15A may be defined as a cell deployment (CD) type 1. The cell deployment scenario in FIG. 15B may be defined as a CD type 2. The cell deployment scenario in FIG. 15c may be defined as a CD type 3. Table 7 below may represent the CD type 1, Table 8 may represent the CD type 2, and Table 9 may represent the CD type 3.

TABLE 7

| | (a)1 | (a)2 | (a)3 | (a)4 |
|---|---|---|---|---|
| Cell X | Case A of | Case B of | Case C of | Case F of |
| Cell Y | FIG. 7 | FIG. 7 | FIG. 7 | FIG. 7 |

TABLE 8

| | Cell 3 (b)1 | Cell 3 (b)2 | Cell 3 (b)3 | Cell 3 (b)4 |
|---|---|---|---|---|
| Cell X | Case A of | Case B of | Case C of | Case F of |
| Cell Y | FIG. 7 | FIG. 7 | FIG. 7 | FIG. 7 |

TABLE 9

| | (c)1 | (c)2 | (c)3 | (c)4 |
|---|---|---|---|---|
| Cell X | Case A of | Case B of | Case C of | Case F of |
| (Cell 3) | FIG. 7 | FIG. 7 | FIG. 7 | FIG. 7 |
| Cell Y | | | | |
| (Cell 4) | | | | |

In FIG. 10A, it may be assumed that MCG bearers, split bearers, and SCG bearers are terminated at all MNs. In FIG. 10A, it may be assumed that MCG bearers, split bearers, and SCG bearers are terminated at all SNs. A mixed terminated state may also be assumed. In the mixed terminated state, some MCGs (e.g. split bearers or SCG bearers) may be terminated at the MN, while other MCGs (e.g. split bearers or SCG bearers) may be terminated at the SN. The termination point may be between the BS and CN or between the CU and CN. In (b1) and (b2) of the CD type 2 in Table 8, a transport network layer (TNL) portion of the terminated UP may remain unchanged, and a CN-BS TNL portion corresponding to the SN may not need to be changed. This is because the CN-BS TNL is managed within the same CU.

In (c1) and (c2) of the CD type 3 in Table 9, a logical change to the TNL portion of the terminated UP may be required. Practically, the TNL portion may be reused without change, and the CN-BS TNL corresponding to the SN may not need to be changed. This is because the CN-BS TNL is managed within the same CU. Consequently, if (b1) and (b2) of the CD type 2 in Table 8 and (c1) and (c2) of the CD type 3 in Table 9 are controlled within the same CU, all-MN-terminated state, all-SN-terminated state, and mixed terminated state may not need to be critically considered. Within the same CU, the same TNL may be maintained (e.g. used), or the TNL may be changed. In (b3) and (b4) of the CD type 2 in Table 8 and (c3) and (c4) of the CD type 3 in Table 9, changes or maintenance of bearer-specific termination points through the RRC reconfiguration message in PH1 of FIG. 6 regarding radio access may be shared between the UE and NW. The change to termination points may be considered in Step 4 of FIG. 8B.

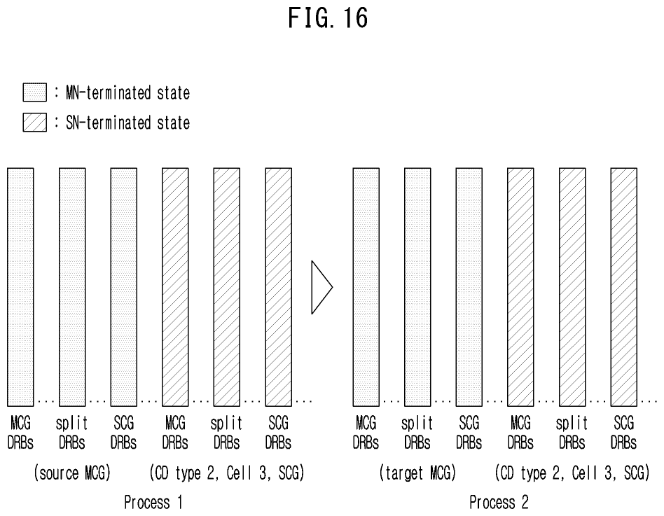

FIG. 16 is a conceptual diagram illustrating processes for (b)3 and (b)4 of the CD type 2 in Table 8.

Referring to FIG. 16, in Process 1, MCG bearers, split bearers, and SCG bearers may be in the MN-terminated state in certain cases, while in other cases, they may be in the SN-terminated state. In other words, in Process 1, MCG bearers, split bearers, and SCG bearers may be in a mixed terminated state. The ULE and the NW (e.g. source node such as a source CU or source BS, and target node such as a target CU or target BS) may share the MCG list (e.g. LTM MCG list) shown in FIG. 11A and the SCG list (e.g., LTM SCG list) shown in FIG. 11B.

The source MCG may be linked to the SCG, and the target MCG may be linked to the same SCG as the SCG linked to the source MCG. Among the SCG information associated with the source MCG and the SCG information associated with the target MCG, portions of data forwarding information between nodes in the NW may be preconfigured differently. When the cell switch command is received in PH2 of FIG. 6, the UE may naturally maintain the SN-related (CN-BS) termination portion (e.g. termination point) without modification based on the information in the MCG list and/or SCG list held by the UE and the preconfigured information held by two nodes in the NW (e.g. CU-CU or BS-BS).

Comparing Process 1 and Process 2 in FIG. 16, the MCG bearers, split bearers, and SCG bearers in the source MN-terminated state may transition to the target MN-terminated state, while the MCG bearers, split bearers, and SCG bearers in the source SN-terminated state may utilize the capacity of the SN without any change in configuration.

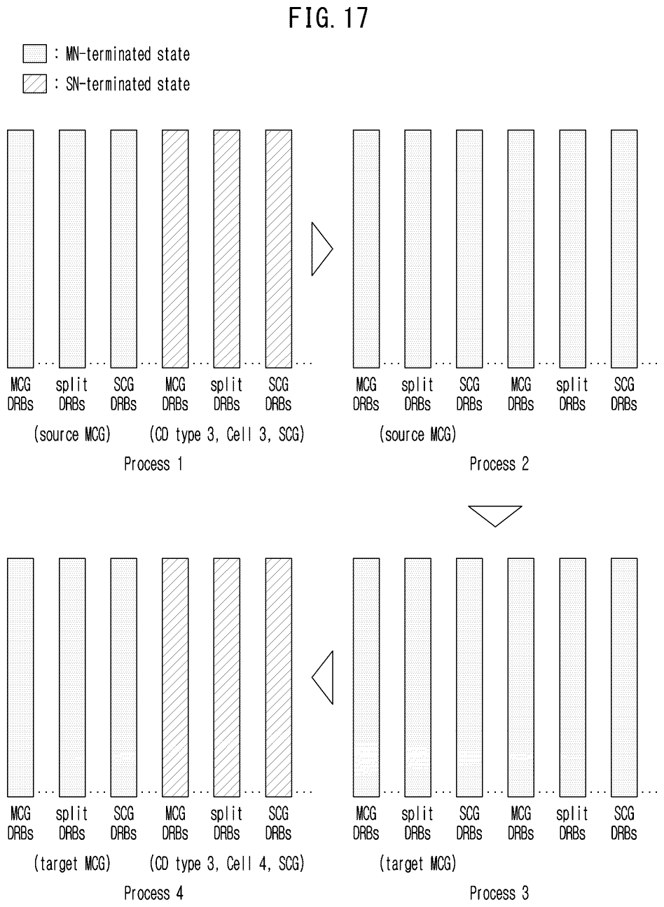

FIG. 17 is a conceptual diagram illustrating processes for (c)3 and (c)4 of the CD type 3 in Table 9.

Referring to FIG. 17, in Process 1, MCG bearers, split bearers, and SCG bearers may be in the MN-terminated state in some cases, while in other cases, they may be in the SN-terminated state. In other words, in Process 1, MCG bearers, split bearers, and SCG bearers may be in a mixed terminated state. In the cell deployment scenario of FIG. 15C, there may be no shared SN available. The SN available to Cell X may differ from the SN available to Cell Y Before the transmission of the cell switch command in PH2 of FIG. 6, the configuration included in the RRC reconfiguration message of PH1 of FIG. 6 may be changed as shown in Process 2 of FIG. 17.

Comparing Process 1 and Process 2 in FIG. 17, MCG bearers, split bearers, and SCG bearers in the SN-terminated state may transition to the MN-terminated state, while MCG bearers, split bearers, and SCG bearers in the source SN termination state may utilize the capacity of the SN without any change in configuration. This operation may be performed through the RRC reconfiguration message in PH1 of FIG. 6 and/or Step 3 of FIG. 8A (e.g. a procedure in the NW). After receiving the cell switch command in PH2 of FIG. 6, the UE may naturally change the termination state as shown in Process 3 of FIG. 17, based on the information in the MCG list and/or SCG list held by the UE and the preconfigured information held by two nodes (e.g. CU-CU or BS-BS) in the NW. Finally, if the SCG can be utilized in the target MCG to which the UE has moved, the termination state for the SCG may be transitioned to the SN-terminated state as appropriate for a situation.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a user equipment (UE), comprising:
performing a lower-layer triggered mobility (LTM) preparation phase for LTM candidate configuration;
executing an LTM procedure based on a layer-1 (L1) measurement result for one or more candidate cells indicated by the LTM candidate configuration; and
completing the LTM procedure when a cell switch procedure according to the LTM procedure is completed.

2. The method according to claim 1, wherein the performing of the LTM preparation phase comprises:
transmitting a measurement report to a base station;
receiving, from the base station, a radio resource control (RRC) reconfiguration message including the LTM candidate configuration generated based on the measurement report; and
transmitting an RRC reconfiguration complete message to the base station in response to the RRC reconfiguration message.

3. The method according to claim 2, wherein the LTM candidate configuration includes at least one of a master cell group (MCG) list or a secondary cell group (SCG) list, the MCG list includes information on one or more candidate MCGs which the UE is able to access, and the SCG list includes information on one or more candidate SCGs which the UE is able to access.

4. The method according to claim 2, wherein the RRC reconfiguration message further includes L1 measurement configuration, wherein the L1 measurement configuration includes information on one or more beam measurement instances that are to be measured.

5. The method according to claim 4, wherein the one or more beam measurement instances indicated by the L1 measurement configuration are one or more beam measurement instances having a high priority among all beam measurement instances for all candidate beams.

6. The method according to claim 5, wherein the one or more beam measurement instances having the high priority include at least one of a beam measurement instance for an MCG primary cell (PCell), a beam measurement instance for an SCG primary secondary cell (PSCell), or a beam measurement instance for a beam affecting at a cell boundary.

7. The method according to claim 1, wherein the executing of the LTM procedure comprises:
transmitting an L1 measurement report to a base station;
in response to execution of the LTM procedure being determined based on the L1 measurement report, receiving a cell switch command from the base station; and
performing a detach procedure for a source cell and a procedure of applying configuration for a target cell,
wherein the L1 measurement report includes a measurement result for the one or more candidate cells indicated by the LTM candidate configuration.

8. The method according to claim 7, wherein the L1 measurement report includes at least one of a cell identifier (ID), beam information of a cell corresponding to the cell ID, or a triggering condition of the L1 measurement report.

9. The method according to claim 7, wherein the cell switch command includes at least one of information indicating a type of a cell group (CG) which the UE is to access or an index for the CG which the UE is to access, and the type of the CG indicates MCG or SCG.

10. The method according to claim 1, further comprising: before executing the LTM procedure, performing an early synchronization procedure for the one or more candidate cells indicated by the LTM candidate configuration, wherein the early synchronization procedure includes at least one of a downlink (DL) synchronization procedure or an uplink (UL) synchronization procedure.

11. A method of a base station, comprising:
performing, with a user equipment (UE), a lower-layer triggered mobility (LTM) preparation phase for LTM candidate configuration;
executing an LTM procedure for the UE based on a layer-1 (L1) measurement result for one or more candidate cells indicated by the LTM candidate configuration; and
completing the LTM procedure when a cell switch procedure according to the LTM procedure is completed.

12. The method according to claim 11, wherein the performing of the LTM preparation phase with the UE comprises:
receiving a measurement report from the UE;
generating the LTM candidate configuration based on the measurement report;
transmitting, to the UE, a radio resource control (RRC) reconfiguration message including the LTM candidate configuration; and
receiving an RRC reconfiguration complete message from the UE in response to the RRC reconfiguration message.

13. The method according to claim 12, wherein the LTM candidate configuration includes at least one of a master cell group (MCG) list or a secondary cell group (SCG) list, the MCG list includes information on one or more candidate MCGs which the UE is able to access, and the SCG list includes information on one or more candidate SCGs which the UE is able to access.

14. The method according to claim 12, wherein the RRC reconfiguration message further includes L1 measurement configuration, wherein the L1 measurement configuration includes information on one or more beam measurement instances that are to be measured.

15. The method according to claim 14, wherein the one or more beam measurement instances indicated by the L1 measurement configuration are one or more beam measurement instances having a high priority among all beam measurement instances for all candidate beams.

16. The method according to claim 11, wherein the executing of the LTM procedure comprises:
receiving an L1 measurement report from the UE;
determining whether to execute the LTM procedure based on the L1 measurement report; and
in response to determining to execute the LTM procedure, transmitting a cell switch command to the UE,
wherein the L1 measurement report includes a measurement result for the one or more candidate cells indicated by the LTM candidate configuration.

17. The method according to claim 16, wherein the L1 measurement report includes at least one of a cell identifier (ID), beam information of a cell corresponding to the cell ID, or a triggering condition of the L1 measurement report.

18. The method according to claim 16, wherein the cell switch command includes at least one of information indicating a type of a cell group (CG) which the UE is access or an index for the CG which the UE is to access, and the type of the CG indicates MCG or SCG.

19. A user equipment (UE) comprising at least one processor, wherein the at least one processor causes the UE to perform:
performing a lower-layer triggered mobility (LTM) preparation phase for LTM candidate configuration;
executing an LTM procedure based on a layer-1 (L1) measurement result for one or more candidate cells indicated by the LTM candidate configuration; and
completing the LTM procedure when a cell switch procedure according to the LTM procedure is completed.

20. The UE according to claim 19, wherein in the performing of the LTM preparation phase, the at least one processor causes the UE to perform:
transmitting a measurement report to a base station;
receiving, from the base station, a radio resource control (RRC) reconfiguration message including the LTM candidate configuration generated based on the measurement report; and
transmitting an RRC reconfiguration complete message to the base station in response to the RRC reconfiguration message.
